(19) United States
(12) Patent Application Publication
(10) Pub. No.: US 2020/0143240 A1
(43) Pub. Date: May 7, 2020

(54) ROBUST ANTI-ADVERSARIAL MACHINE LEARNING

(71) Applicant: D5AI LLC, Maitland, FL (US)

(72) Inventor: James K. BAKER, Maitland, FL (US)

(21) Appl. No.: 16/619,278

(22) PCT Filed: Jun. 11, 2018
(86) PCT No.: PCT/US2018/036916

§ 371 Date: Dec. 4, 2019

Related U.S. Application Data
(60) Provisional application No. 62/518,302, filed on Jun. 12, 2017.

(51) Int. Cl. G06N 3/08; G06N 3/04

(52) U.S. Cl. CPC G06N 3/08; G06N 3/04

(57) ABSTRACT

Systems and methods to improve the robustness of a network that has been trained to convergence, particularly with respect to small or imperceptible changes to the input data. Various techniques, which can be utilized either individually or in various combinations, can include adding biases to the input nodes of the network, increasing the minibatch size of the training data, adding special nodes to the network that have activations that do not necessarily change with each data example of the training data, splitting the training data based upon the gradient direction, and making other intentionally adversarial changes to the input of the neural network. In more robust networks, a correct classification is less likely to be disturbed by random or even intentionally adversarial changes in the input values.

### PRIORITY CLAIM

The present application claims priority to U.S. provisional application Ser. No. 62/518,302, filed Jun. 12, 2017, with the same title and inventor as noted above, and which is incorporated herein by reference in its entirety.

### CROSS-REFERENCE TO RELATED APPLICATIONS

The present application is related to the following applications, all of which are incorporated herein by reference in their entirety: PCT Application No. PCT/US17/52037, entitled “LEARNING COACH FOR MACHINE LEARNING SYSTEM”; PCT Application No. PCT/US18/20887, entitled “LEARNING COACH FOR MACHINE LEARNING SYSTEM”; PCT Application No. PCT/US18/27744, entitled “MULTI-STAGE MACHINE LEARNING AND RECOGNITION”; PCT Application No. PCT/US18/35275, entitled “ASYNCHRONOUS AGENTS WITH LEARNING COACHES AND STRUCTURALLY MODIFYING DEEP NEURAL NETWORKS WITHOUT PERFORMANCE DEGRADATION”; and PCT Application No. PCT/US18/35598, entitled “DATA SPLITTING BY GRADIENT DIRECTION FOR NEURAL NETWORKS.”

### BACKGROUND

In classification tasks by deep neural networks, it has recently been discovered that small, even imperceptible changes in the input can completely change the classification computed by the network. More specifically, if many input values are all changed by small amounts at the same time, in just the right direction, the small changes in many input values can simultaneously produce a large change in the output of the classification network. This property is undesirable because one of the principles underlying the interpretation of classifications is the implicit assumption that inputs that are very similar to each other should usually have very similar classifications. Although this implicit assumption seems usually to be true for randomly chosen changes in the input, it appears to almost always be false for changes in a carefully chosen adversarial direction.

### SUMMARY

In one general aspect, the present invention is directed to systems and methods for training a machine learning system, e.g., a deep neural network, to make the machine learning system more robust, particularly with respect to small or imperceptible changes to input data. That is, for example, for a machine learning system trained or generated according to aspects of the present invention, the correct classification is less likely to be disturbed by adversarial changes in the input data values.

Aspects of the present invention can be used to improve many different types of machine learning systems, including deep neural networks, in a variety of applications. For example, aspects of the present invention can improve recommender systems, speech recognition systems, and classification systems, including image and diagnostic classification systems, to name but a few examples, principally by making them more robust to small or imperceptible changes to the input data. These and other benefits of the present invention will be apparent from the description that follows.

### BRIEF DESCRIPTION OF THE FIGURES

Various aspects of the present invention are described herein by way of example in conjunction with the following figures, wherein:

FIG. 1A is a flow chart of a process for training a machine learning system according to various aspects of the present invention;

FIG. 1B is a diagram of a system, including a machine learning-based learning coach, according to illustrative aspects of the present invention,

FIG. 2 is a diagram of the initialization used to safely add a node to a network in an illustrative aspect of the invention;

FIG. 3 is an illustration of special nodes that are added to a network in an illustrative aspect of the invention;

FIG. 4 is an illustration of more complex special nodes being added to a network in another illustrative aspect;

FIG. 5 is an illustration of another type of node that may be added to a network in aspects of the invention;

FIG. 6 illustrates the use of an autoencoder to partition the data for more robust training;

FIG. 7 illustrates an aspect of the invention that trains an autoencoder to generate data that causes errors in classification to provide training data to make the trained network more robust;

FIG. 8 illustrates an aspect of the invention that uses partially supervised learning to train a de-noising autoencoder;

FIG. 9A illustrates various aspects of the invention that construct robust ensembles of classifiers based on the training data generated as in FIG. 7;

FIG. 9B illustrates various aspects of the invention that utilized robust ensembles of classifiers constructed from the training data generated as in FIG. 7; and

FIG. 10 illustrates an aspect of the invention that reduces the amount of computation required by some of the aspects illustrated in FIGS. 9A and 9B.

FIG. 11 illustrates several aspects of the invention relating to control of hyperparameters in greater detail than FIG. 1A.

FIG. 12 illustrates several aspects of the invention relating to the control of the learning process by a learning coach.

### DETAILED DESCRIPTION

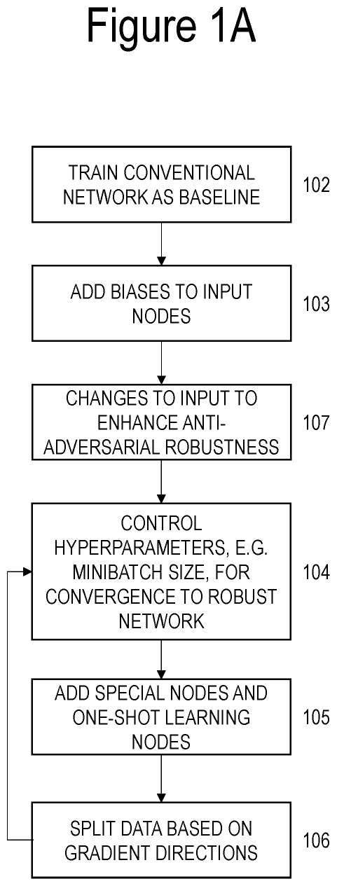

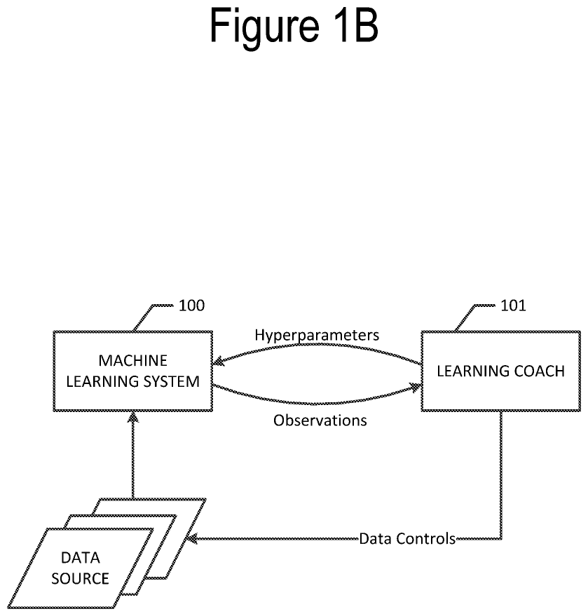

FIG. 1A is a block diagram that shows an exemplary process that can be performed, according to illustrative aspects of the present invention and with reference to system diagram of FIG. 1B, under the control of a learning coach 101 to generate (or train) a machine learning system 100 with enhanced robustness. The trained machine learning system 100 could comprise, and is generally described herein for the sake of illustration, as having a deep neural network architecture, although in other aspects of the present invention the machine learning system 100 could have another type of machine learning architecture. The learning coach 101 itself may comprise a machine learning system such as described in further detail in PCT Patent Application No. PCT/US17/52037 (hereinafter “the '037 Application”) and PCT Patent Application No. PCT/US18/20887 (hereinafter “the '887 Application”), each of which is incorporated by reference in its entirety. In one aspect, the steps of the process illustrated in FIG. 1A are controlled by a learning coach 101. According to various aspects of the present invention, the process illustrated in FIG. 1A can include the steps of: training a conventional network as a baseline 102; adding biases to input nodes of a network 103; making changes in hyperparameters 104, e.g. increasing the size of a minibatch, lowering the temperature of a node, or changing the activation function of a node; adding special nodes to a network 105; splitting data based on the direction of gradients in a network 106; and making additional changes, particularly to the input, to enhance the anti-adversarial response of the network 107. Details about the steps 102-107 shown in FIG. 1A will be explained in more detail below in association with other diagrams. In some aspects of the invention, only some of the steps 102-107 shown in FIG. 1A are used. That is, in various aspects, not all of the steps 102-107 are required in every aspect. In addition, although aspects of the present invention are generally described as including the learning coach 101, in alternative aspects of the present invention, one or more of the processes 102-107 shown in FIG. 1A could be controlled by a fixed set of rules, without a learning coach.

As described in the '037 Application and the '887 Application, among other things, the learning coach 101 can provide detailed customized control of the hyperparameters that control the learning process for the machine learning system 100, which as mentioned above can comprise a deep neural network classifier. An illustrative aspect of training a neural network based on stochastic gradient descent, using partial derivatives computed by backpropagation, with updates of the learned parameters done in minibatches, and with the hyperparameters controlled by a learning coach, is shown in the following pseudo-code:

```
Pseudocode of stochastic gradient descent with gradient normalization and
learning coach control
  1. a_{l-1,0}(m) = 1, is constant, so w_{l,0,j} is a bias for node j inlayer l
  2. For each epoch until stopping criterion is met
    a. Repeat for each minibatch in epoch:
      1. Input a set (minibatch number t) of training examples
      2. For each training example m, set a_{0,i}(m) and perform the
        following steps:
        i. Feedforward (softmax output): For each l = 1, 2, . . . , L − 1
          compute z_{l,j}(m) = Σᵢ₌₀ⁿ^{ₗ} w_{l-1,i,j}a_{l-1,i}(m), a_{l,j}(m) =
          σ(z_{l,j}(m); T_{l,j,t});
        ii. Softmax output:
          ${a}_{L , k} = {e}^{{z}_{k / {T}_{L , k , t}}} / ( {\sum }_{j} {e}^{{z}_{j} / {T}_{L , j , t}} ) ; {s}_{L , n} = 1 ;$
        iii. Output error gradient (m):
              ${δ}_{L , j} ( m ) = - \frac{{y}_{j} ( m ) - {a}_{L , j} ( m )}{{n}_{L} {T}_{L , j , t}}$
        iv. Backpropagate error gradient: For each 1 = L-1,
          L-2, . . . , 2, 1 compute
${δ}_{l - 1 , i} ( m ) = ( {a}_{l - 1 , i} ( m ) ( 1 - {a}_{l - 1 , i} ( m ) ) {\sum }_{j = 1}^{{n}_{l}} {w}_{l , i , j} {δ}_{l , j} ( m ) ) / ( {s}_{l - 1} {T}_{l - 1 , i , t} )$
      3. Computer gradient for minibatch:
            Δ_{l-1,i} = Σₘ₌₁^{M} a_{l-1,i}(m)δ_{l,j} (m)/M
      4. Compute momentum:
          v_{l,i,j} → v_{l,i,j}′ = μ_{l,i,j}v_{l,i,j} − η_{l,i,j}Δ_{l-1,i}
      5. Compute norm for layer:
                sₗ = Maxᵢ|Δ_{l,i}|
6. Gradient descent: For each 1 = L-1, L-2, . . . , 2, 1 update the weights
            w_{l,i,j} → w_{l,i,j}′ = w_{l,i,j}(1 − λ_{l,i,j}) − v_{l,i,j}′
```

As shown by the aspect illustrated in FIG. 1A, exemplary aspects of the present invention can employ one or more techniques embodied as steps 103, 107, 104, 105, and 106 to make the machine learning system 100 more robust. Robustness of a machine learning system 100 can be defined as making a correct classification less likely to be disturbed by random or even intentionally adversarial changes in the input values. The hyperparameters decision controls used in steps 104-106 may be set by fixed rules or may be controlled by learning coach 101 in FIG. 1B. The steps 104-106 may be performed in any order. As indicated by the arrow from 106 back to 104, the steps 104-106 may be performed repeatedly during the course of the training process. During each repetition of the steps 104-106, any subset of the steps may be performed.

In the aspect illustrated in FIG. 1A, the first step 102 is to train a conventional neural network to the best performance that can be achieved without the other special techniques described herein, e.g., steps 103, 107, 104, 105, and 106. This conventional neural network generated at step 102 provides an initial network and a baseline of performance. This “baseline” network is the performance achieved by a conventionally trained network in the absence of any noise or disturbance to the input. In aspects of the invention, the goal is to match this baseline performance even in the presence of such disturbances.

In some aspects, at step 103, the learning coach 101 (see FIG. 1B) adds latent variables to the baseline network as biases to the input values, which are represented by nodes in the lowest or input layer. That is, each input node will have a variable bias that is trained during the training of the neural network. If the partial derivative of the error cost function with respect to any of the input values is non-zero, a correct classification may be changed to an incorrect classification by changes in that input value. The effect of adding these biases is that for a network that has been trained to convergence at a local minimum in the error cost function, these partial derivatives will all have an average value of zero, when averaged across all the training data.

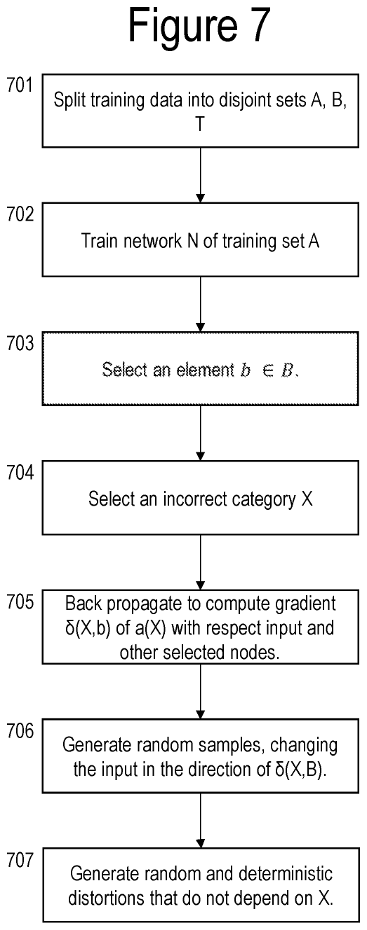

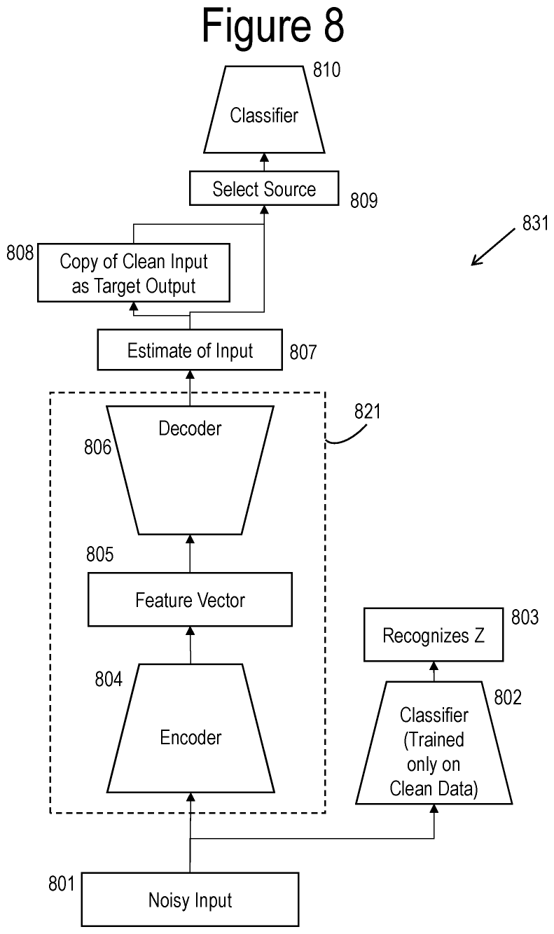

In some aspects, at step 107, the learning coach 101 implements additional processes that are done to avoid the effects of many specific types of disturbances, including changes to the input that are designed to affect the input in a maximally adversarial way. Examples of some embodiments of the processes of step 107 will be discussed in more detail in association with FIGS. 7 and 8. Another example embodiment of step 107 is to apply a first linear or non-linear differentiable transformation, which may be the identity transformation, followed by a quantization, such as rounding each output value of the first transformation to the nearest integer, optionally followed by a second linear or non-linear differentiable transformation. The quantization step makes the output of the set of transformations be unchanged for most small incremental changes in the input values. The linear and non-linear transformation allow the quantization to be scaled according to the needs of the application and allow the output of the transformation to be scaled for efficient learning by the neural network. Other example embodiments that include a quantization step can achieve similar results.

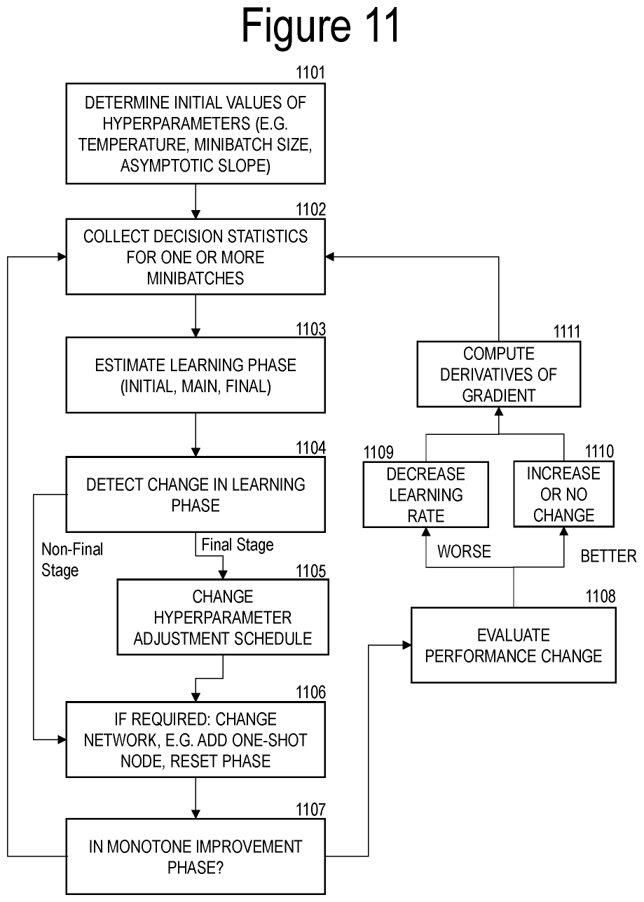

In some aspects, at step 104, the learning coach 101 controls one or more hyperparameters in order to help guide the learning process to converge to a network that is more robust against adversarial examples. For example, the learning coach 101 may gradually increase the size of the minibatches to give more accurate estimates of the gradient. As an additional example, the learning coach 101 may control the temperature or other customized hyperparameter of an individual node in a way that increases the robustness of the node at convergence. This aspect of step 104 is discussed in more detail in association with FIG. 11.

The sigmoid or logistic activation function is defined by σ(x)=1/(1+exp(−x)). The temperature hyperparameter T is introduced by defining

$$σ ( x ; T ) = 1 / ( 1 + exp ( - \frac{x}{T} ) ) .$$

The hyperparameter T in this definition is called “temperature” because it is analogous to the representation of temperature in functions that occur in statistical physics modeling thermodynamic processes. The standard sigmoid function is equivalent to a temperature of 1 in the parametric sigmoid function. The sigmoid function is a monotonic function with values in the range (0, 1), with its maximum rate of change occurring at x=0. Raising the temperature in the parametric sigmoid function decreases the rate at which the function changes value and spreads out the interval for any change, maintaining the same range.

A temperature-like hyperparameter can be defined for other activation functions. For example, a piecewise linear activation function can be defined by f(x)=0 for x<0; =x=x f for 0≤x ≤1; =1 for 1<x. This activation function can viewed either as a rectified linear unit (ReLU) with a limited range or as a piecewise linear approximation to a sigmoid.

A parametric form of this function can be defined by

$$f ( x ; T ) = 0 for x < 0 ; = \frac{x}{T} for 0 \leq x \leq T ; = 1$$

for T<x. The hyperparameter T in this function may also be called temperature or may be referred to as “temperature-like.” In both of these functions, the maximum value of the derivative increases as the temperature is lowered, that is, as T decreases toward 0. Both functions approach the step function step(x)=0 for x<0; =1 for x>0, with the limit undefined for x=0. A similar temperature-like parameter can be defined for any continuous piecewise linear function. Any piecewise constant function can be represented as the limit of such a parametric piecewise linear function as the parameter T goes to 0.

A related hyperparameter is the asymptotic slope of the activation function f(x) as x goes to infinity or negative infinity. The asymptotic slope is zero for the sigmoid function, but it may be non-zero for other activation functions. For example, the asymptotic slope of the ReLU function as x goes to plus infinity is 1. A parametric activation in which a hyperparameter controls the asymptotic slopes is useful in some aspects of this invention.

The hyperparameters controlled in step 104 may lead the activation function of a node to converge toward a step function, a staircase function, or other piecewise constant function. A piecewise constant function is unchanged by small incremental changes in its input, except at the discontinuities in the piecewise constant function. For random input with a continuous probability distribution, the probability of the input being at any of a finite number of points of discontinuity is zero. Thus, a piecewise constant function is very robust against incremental changes to its input.

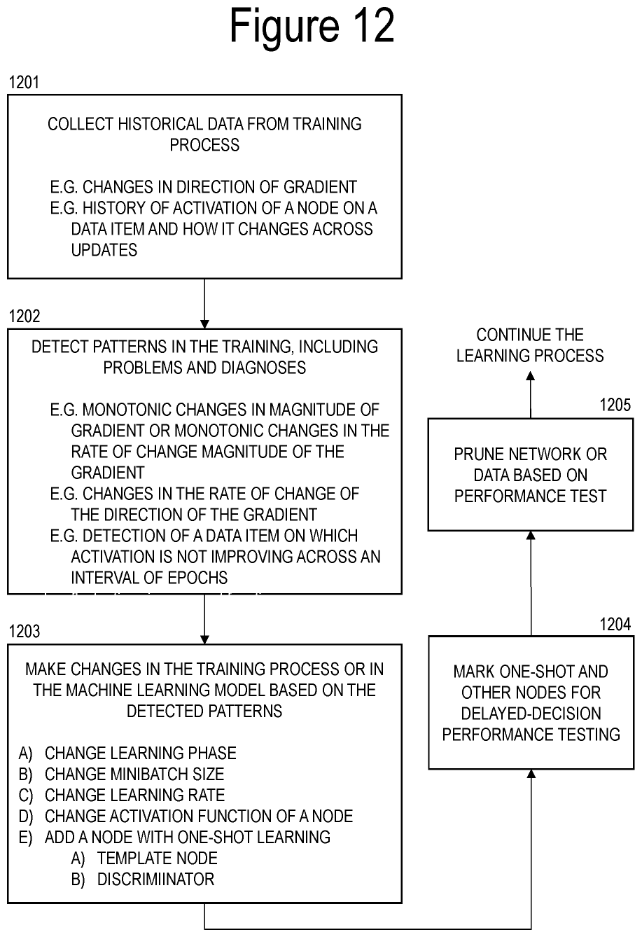

Controlling the size of the minibatch helps in the management of the final convergence of the iterative stochastic gradient descent learning process. As the size of the minibatches for the network is increased, the value of each partial derivative averaged over the minibatch approaches the value averaged over the entire training set, that is, to the true gradient. In some aspects, the size of the minibatch may be increased until the entire training set is one batch, if that is necessary to make the gradient of the error cost with respect to the inputs be consistent among the minibatches. As the size of the minibatch is increased, the minibatch-based estimate of the gradient becomes more accurate and the estimate of the gradient varies less from one minibatch to another. Note that this favorable property of increasing the minibatch size, applies to minibatch-based gradient descent in general. It is not limited to merely to improving robustness against adversarial examples. Nor is it limited to neural networks. On the other hand, increasing the minibatch size earlier in the training process causes the learning process to require more updates. In one illustrative aspect, the minibatch size is not increased gradually, but, after convergence, a single pass is done with the entire training set as a batch. More details of controlling the minibatch size or other hyperparameters according to the phase of the learning process are discussed in association with FIGS. 11 and 12.

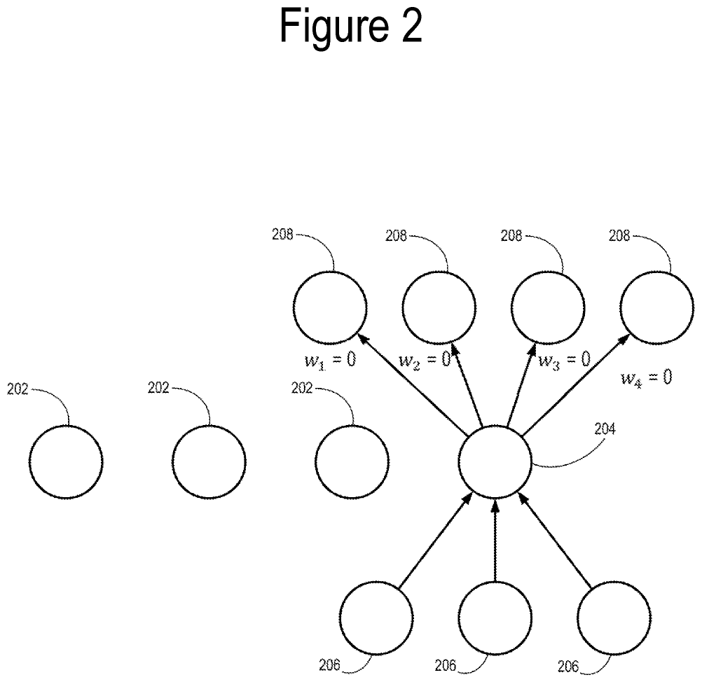

In some aspects, at step 105, the learning coach 101 adds one or more special extra nodes to the baseline neural network. These extra or special nodes may be added before training, during training, or after training of the non-augmented baseline network. If some of the extra nodes are added after the learning has converged, additional training can be done to fine-tune the augmented baseline network. Examples of these special extra nodes will be explained in more detail in association with FIGS. 2, 3, 4 and 5.

Some of these special nodes have non-monotonic activation functions, such as x², |x|, (x−y)², and |x−y|, each of which is non-monotonic and also has a unique minimum. A node with any of these activation functions can be used as a template node, in which an input value to the node is compared to another input value or to the bias value for the node. In one aspect, when a pattern matches the template to which the pattern is compared, the score (i.e., activation) is minimized. A vector template can be formed by combining a weighted sum of individual-variable template nodes using a linear node. Any individual-variable or vector template node may be trained by one-shot learning, that is, by initializing the template to be equal to a single data example and then continuing iterative training, such as stochastic gradient descent from that initialization. A template node can be added to an existing network at any point in the training. In one aspect, when a node is added to a network during training, the weights on it output arcs are initialized to zero (see, e.g., FIG. 2). The ability to add a node to a network and initialize it by one-shot learning is useful in controlling the changes in learning phases in FIG. 11, which in turn is useful in implementing some aspects of step 104 in FIG. 1A.

More generally, FIG. 2 illustrates an embodiment for adding a node, either a conventional node or a special node to an existing network without degrading the performance. As another aspect of step 105, a new node can be added as a linear or logistic discriminator. Such a discriminator can be initialized by one-shot learning from a single pair of data examples by setting the weights on the input arcs to the node to represent the perpendicular bisector of the line between the two example data vectors. The example data vectors can be either input data vectors to the network or the activation values of any set of nodes in lower layers of the network than the layer of the new node. Such a discriminator node can also be initialized using linear regression for a linear node or logistic regression for a sigmoid node to discriminate any pair of disjoint sets of input vectors or lower layer node activations.

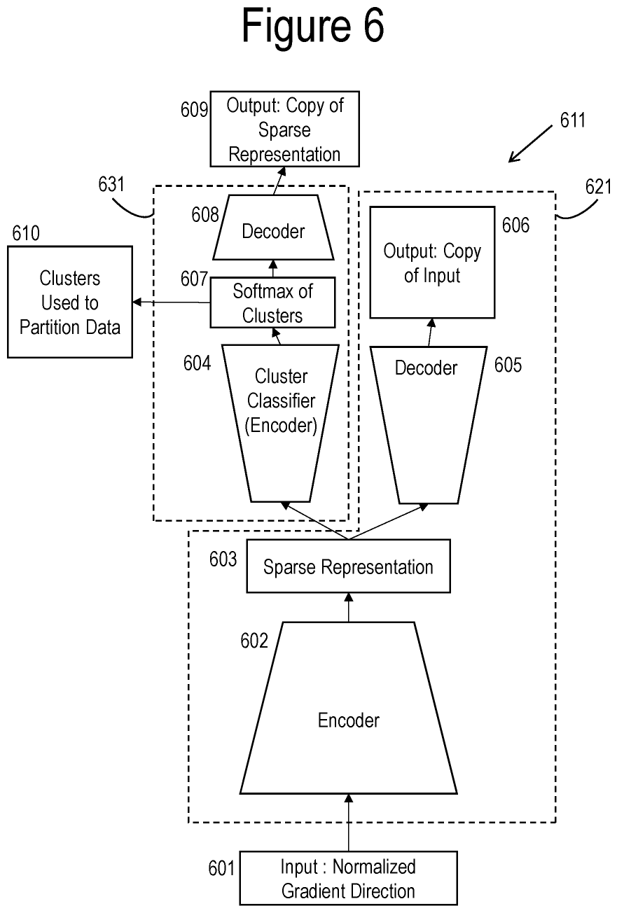

In some aspects, at step 106, the learning coach 101 implements a data splitting process. This data splitting creates an ensemble or other multi-network system that facilitates the task of making the machine learning system 100 more robust. Examples of the process of splitting the data and its effect will be discussed in more detail in association with FIG. 6. PCT Application No. PCT/US35598, entitled “DATA SPLITTING BY GRADIENT DIRECTION FOR NEURAL NETWORKS,” filed Jun. 1, 2018, which is incorporated by reference in its entirety, explains in more details the various techniques of data splitting.

An aspect of the invention adds extra nodes to the baseline network generated at step 102. These extra nodes have special properties that can increase the robustness of the baseline network and may also increase its overall performance.

FIG. 2 shows an illustrative aspect of the invention in which a new node 204 is added to a neural network, e.g., the baseline neural network, containing existing nodes 202 without degrading the performance of the neural network. A network with extra nodes, with nothing removed and no paths blocked can always compute a superset of anything computable by the smaller network. Although the extra nodes result in a different learning process, these extra nodes can be added in such a way that there is no degradation in performance from a previously optimized network. PCT Application No. PCT/US35275, entitled “ASYNCHRONOUS AGENTS WITH LEARNING COACHES AND STRUCTURALLY MODIFYING DEEP NEURAL NETWORKS WITHOUT PERFORMANCE DEGRADATION,” filed May 31, 2018, which is incorporated by reference in its entirety, explains in more detail the methods for adding such nodes. For example, when a new node 204 is added to the neural network, the incoming arcs from preceding nodes 206 can be initialized to random weights and the outgoing arcs to subsequent nodes 208 can be initialized to a weight of zero.

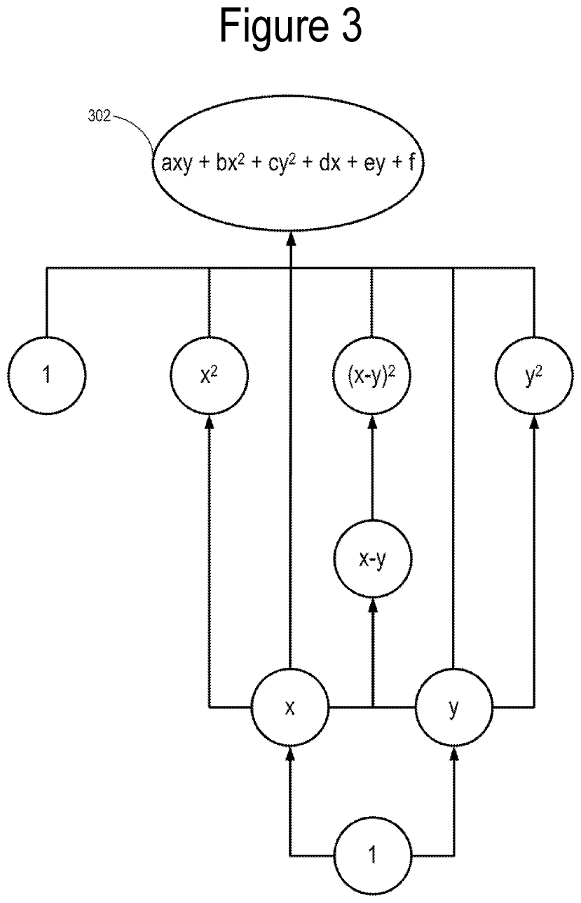

One type of special node allows the network to compute higher order polynomials in the values of other nodes, including the input nodes. One aspect of such a capability is shown in FIG. 3. The special nodes in this aspect directly compute differences of two nodes and the square of the activation value of a single incoming node. However, with multiple layers, any polynomial may be computed by combinations of these nodes. For example, a polynomial such as xy=[x²+y²−(x−y)²]/2 or other such second order polynomial may be computed by combing the nodes as needed. Moreover, higher order polynomials can be computed with multiple layers of second order polynomials.

The advantage of having a node that computes a second order polynomial, such as xy, is that the partial derivative of the weight of an arc leaving that node will be proportional to the second order derivative α²C/αxαy. In turn, there are several advantages of having a learned parameter that has a partial derivative value that represents what was a second order derivative in the original network. For example, in the stochastic gradient descent at a saddle point all the regular first order derivatives would be zero, but some linear combinations of second order derivatives would be negative, allowing a step in a direction of decreasing error cost in the expanded network that cannot be done as a gradient step in the original network.

More significant for the issue of increasing robustness, training a network with such nodes to convergence means that the partial derivatives of the error cost function will be zero for these nodes as well as for all the regular nodes. In other words, in addition to the regular gradient being zero, all the second order partial derivatives that are directly represented by nodes would be zero as well. Having all first and some second order partial derivatives equal to zero means that small changes in the inputs will only make small changes in the output, which satisfies the condition for robustness.

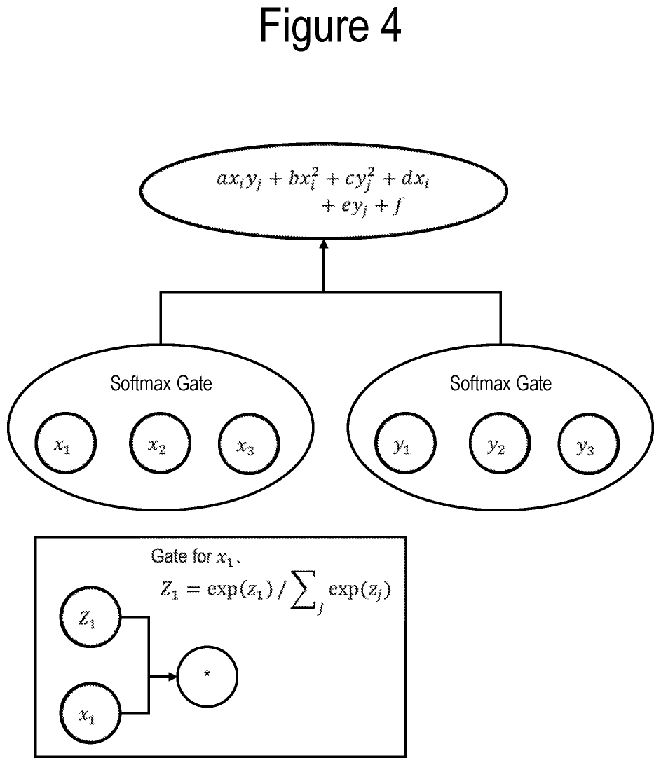

In a neural network with a large number of input features (e.g., 1,000 or more), it is impractical to directly represent all pairs of input features. FIG. 4 illustrates an aspect in which the network can learn which pairs of input features should be combined into second order or higher order polynomials. FIG. 4 illustrates an aspect of a special node called a “softmax gate.” A softmax gate is defined as a set of nodes whose joint set of activations represent a softmax set of values. The softmax values are used as multiplicative values to gate the output values of a second set of nodes. A set of nodes collectively represent a softmax activation if the activation of node k is determined by the formula Zₖ=exp(zₖ)/Σⱼexp(zⱼ), where zⱼ is the input to node j. Note that the activation of each node in the set is non-negative, and that the activations sum to one. In training, typically one of the nodes will have its activation converge to 1 while the rest of the nodes' activations all converge to 0.

As shown in the expanded representation for x₁ in FIG. 4, each value xᵢ is multiplied by a gating value Zᵢ that is between 0 and 1. As one of the Z values converges to 1, the set of softmax gate nodes effectively selects one of the x values to be used in the binomial expression. The set of softmax gates for the vector of y values selects which y is to be used in the binomial. In an illustrative aspect, under control of learning coach 101, some pairs of nodes are preselected for creation of binomial nodes and some pairs are selected by the softmax gates method illustrated in FIG. 4.

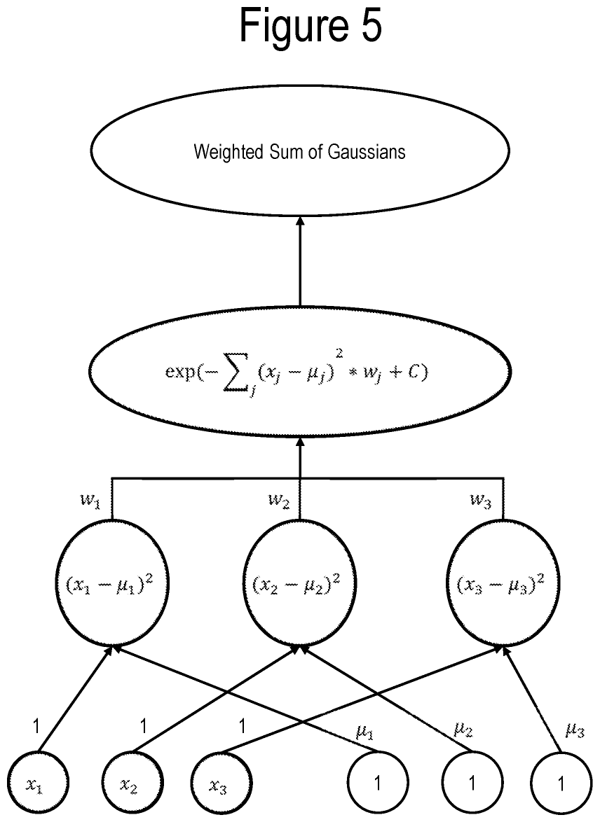

In other illustrative aspects, the absolute value of the difference |x−y| is used rather than the square of the difference (x−y)², and other norms may be used as well in yet other aspects. The use of norms of differences of values also relates to another type of special nodes: template-based nodes. FIG. 5 illustrates an aspect of a template-based node functioning as a model for Gaussian mixture distributions. The illustrative example shown in

FIG. 5 assumes the Gaussian distribution has a diagonal covariance matrix. This assumption is not necessary, as full covariance models or banded covariance models could be used instead. However, with a given number of parameters, there is a trade-off between the number of non-zero values in the inverse of the covariance matrix and the number of mixture components.

The Gaussian mixture is just one example of a template-based model. Any other form of measuring the distance between one example and another can be used in place of the Gaussian kernel. The defining characteristic of a template-based model is that there is a set of numbers that are compared with node activations, but unlike node activations, these comparison numbers do not change with each input data example. They may be learned parameters that are re-estimated with each minibatch update. If they are modeling or approximating a parametric probability distribution, they may be a (subset of the) sufficient statistic for that distribution. The values μᵢ in FIG. 5, for example, are learned parameters and, together with the weights wᵢ, are sufficient statistics for the Gaussian distribution with diagonal covariance.

In FIG. 5, the template parameters are represented by the biases, that is the connection weights to the nodes with fixed value 1. In another aspect, each node computing the square of a difference could have an extra capability—the capability to store and retrieve the value μᵢ. In another aspect, a single super-node could store all values and the covariance matrix as well. All these aspects, and many other template-based models, share a valuable property: their parameters can be initialized from a single example. This property is called “one-shot learning.” The values from the single example are used for the μᵢ, and the weights wᵢ can be initialized to 1.

Some other properties of template-based nodes need special care, but can be valuable as well. The maximum likelihood estimator of μᵢ, the sample mean, for example, is not robust when estimating a single Gaussian. Outliers can have a large influence in estimating This problem is reduced if the mixture distribution has enough components to handle the outliers.

By definition, any norm or measure of distance D will be non-negative. Therefore, the negative exponential exp(−D) will be between zero and one. Without taking the negative exponential, the norm or distance measure can grow without bound. A vector of points <wᵢ> that is at a great distance from <μᵢ> will have a large value for D, which is an unfavorable property for robustness. The value of exp(−D), on the other hand, rapidly approaches 0 as D gets large, as does its derivative. Therefore, for robustness, in various aspects any norm or distance computed in a template-based model can be applied to a negative exponential activation function, or to an exponential-like activation, such as softmax. Then, rather than being less robust, the special node is more robust than regression-based nodes in the sense that the derivative of their activation is close to zero relative to changes in data that is far from the template values.

Both the polynomial special nodes and the template-based special nodes introduce additional parameters and extra computation. Therefore, the learning coach 101 (see FIG. 1B) can take on other capabilities in addition to controlling the hyperparameters in various aspects. One of these capabilities is the ability to make changes in the structure of the machine learning system 100, in this case to add or delete nodes and arcs to the neural network and to evaluate the performance of the change. Another capability is the ability to measure the performance on a development set separate from the training set and thereby detect the presence of over fitting caused by too many parameters or insufficient regularization. A further capability is the ability to optimize an objective that takes into account cost as well as performance, in this case the cost of the additional computation. With these capabilities, some aspects leave the management of the number of special nodes and of the hyperparameters that control their regularization to the learning coach 101.

Adding a trained bias as a learned parameter to each input feature means that, at convergence, the gradient with respect to the input features, averaged across all the training data, will be zero. However, deliberate adversarial examples are based on making modifications to an individual example. Therefore, the first order effect of the changes will be proportional to the gradient of the error cost with respect to that individual example, not the average of the gradient. Even though the gradient averaged across all the training data may be zero, the norm of the gradient for individual data examples may be large.

The gradient of some data examples may be large if there are enough other data examples with gradients more or less in the opposite direction to balance them.

For purpose of future reference, let N be the network that is the subject of the present discussion, i.e., the network to be made more robust. In an illustrative aspect of step 106 of FIG. 1A, the learning coach 101 separates the training data into two or more disjoint subsets, based on the direction vectors of the gradients of the error cost function with respect to the input nodes. In one illustrative aspect, special polynomial-type nodes are included in the set of nodes for which the gradient direction is computed.

The data split of step 106 can be done by any of the many clustering algorithms that are well known to those skilled in the art of machine learning. Note that these clusters will not be used in identifying the classification categories. It does not matter if the clusters are not well separated and it does not matter if a cluster has representatives of many different classification categories. The data split is for the purpose of separating, from each other, data examples that have gradients with respect to the set of input nodes that point in more or less opposite directions from each other.

As an illustrative example, a clustering algorithm that could be utilized in an aspect of step 106 of FIG. 1A, as well as other purposes, will be described. The clustering algorithm illustrated in FIG. 6 is a double autoencoder 611. An autoencoder is a neural network that is trained to reproduce its input. Because the input itself specifies the target output, an autoencoder can be trained in an unsupervised manner, that is, without knowing the correct classification category for each input data example. Because the identity function is an uninteresting solution, either the architecture of the autoencoder network or a regularization function is used to prevent the training from converging to the identity function as a solution. It should be noted that in FIG. 6, activation proceeds in the direction of the arrows and backpropagation of partial derivatives proceeds in the opposite direction.

In the illustrated aspect, a first autoencoder 621 comprises an encoder 602 (e.g., a deep neural network) and a decoder 605 (e.g., a deep neural network) and a second autoencoder 631 comprises a cluster classifier 604 as an encoder and a decoder 608. The architecture of the double autoencoder 611 forces the neural network to find the sparse intermediate representation 603 or some other low data-bandwidth representation of the provided input 601. In one aspect, the sparse representation 603 includes a sparse feature vector as an n-tuple in which only a minority of the elements of the n-tuple have values different from zero, or other designated default value, such as −1 for the tanh( ) activation function.

In another aspect, the representation 603 is not necessarily sparse, but comprises a feature vector as an n-tuple where n is much less than the dimensionality of the input space. In yet another aspect, the sparse representation 603 includes a parametric representation with the number of parameters much less than the dimension of the space.

The low effective dimensionality of the middle representation layer forces the network to learn a function other than the identity function to reproduce the input. In the aspect illustrated in FIG. 6, first autoencoder 621 has two objectives. In addition to reproducing the input 601 as a copy 606 thereof, it provides the sparse representation 603 generated by the encoder 602 as the input to a second autoencoder 631. The softmax or cluster classifier 604 of the second autoencoder 631 then generates a further sparse representation of the original input 601 as a softmax activation of the node set representing the clusters. The softmax classifier 604 maps the sparse feature vectors into a discrete set of categories and thereby also maps the input vectors into a discrete set of categories or, in other words, clusters 607. The clusters 607 are then utilized to partition 610 the data. The decoder 608 of the second autoencoder 631 further outputs a copy 609 of the sparse representation 603 provided to the second autoencoder 631.

The example input 601 to the double autoencoder shown in FIG. 6 comes from backpropagation on network N. The input vectors 601 to the autocorrelation network are the direction vectors for the gradient of the error cost function for the network N with respect to the input nodes and any other nodes selected by the learning coach 101, such as the polynomial nodes and/or other special nodes discussed above. The direction vector for a vector is created by dividing each element in the vector by the length of the vector. The resulting vector has length one. That is, it lies on the unit sphere and indicates a direction.

The purpose of the clustering 604, whether done by the autocorrelation clustering shown in FIG. 6 or by some other clustering algorithm, is to partition 610 or group together input data for network N where input examples that have similar directions for their gradient, with respect to the input nodes, are grouped together. Likewise, data examples with very different directions for their gradients with respect to the input nodes will be separated.

In one aspect, a copy of the current network N is made for each cluster 607, with the same architecture and the current values of the learned parameters and the connection weights. Then, each copy is retrained using only the data that has been assigned to a single cluster.

If a network obtained by retraining on a single cluster of data still has data examples for which the norm of the gradient with respect to the input nodes is too large, the data splitting, clustering, and retraining is repeated.

Eventually, each of the resulting networks will be robust at least in the sense that all the partial derivatives of the error cost function with respect to the input are small. Even selected second order derivatives are small, if special polynomial nodes have been included. These networks can be used as an ensemble to make a classification. Their results can be combined by any of several methods that are well known to those skilled in the art of machine learning. For example, the score for each category could be the maximum score, the arithmetic average, or the geometric average of the scores for that category averaged across the members of the ensemble.

Alternately, because the data split is unsupervised, that is the computation does not depend on knowledge of the correct classification, the data split can be used as a data assignment stage for a multi-stage classifier. Machine learning systems embodying multi-stage classifiers are described in further detail in PCT Application No. PCT/US18/27744, entitled “MULTI-STAGE MACHINE LEARNING AND RECOGNITION, filed Apr. 16, 2018, which is incorporated by reference in its entirety.

Whether the data split is used to create an ensemble or a multi-stage classifier, the training time after the split is greatly reduced because each network is only trained on a fraction of the data. In a multi-stage classifier, the amount of computation for operation is also reduced.

An aspect of the invention is the ability to generate data that causes errors by the classifier (e.g., the machine learning system 100). This data can then be used to train a classifier to be more robust. One illustrative aspect of this capability can generate a multiplicity of different errors by generating perturbations from the same original data in many different directions. If the number of categories (clusters) of the data is large, changing the input in a large number of different directions can produce different errors. In this illustrative aspect, the output activation to be trained to be robust is a softmax over a multiplicity of categories. For example, there might be tens of thousands of categories in image recognition and hundreds of thousands of categories in a task predicting a word.

An illustrative example of this ability is illustrated in FIG. 7. At step 701, this aspect splits the original training data into three parts A, B, and T and, at step 702, trains a network (e.g., the machine learning system 100) on A.

With the trained network, the following steps can be performed to generate noisy data for training a more robust network. At step 703, an element b∈B is selected. Let the correct category for b be Y(b) and the incorrect category for b be X(b). At step 704, the incorrect category X(b) is selected for b. At step 705, the gradient δ(X, b)=<δᵢ; X> of the activation of the output node corresponding to category X is computed for each selected incorrect category X with respect to, for example, the input vector and any other nodes selected by learning coach 101. At step 706, J random samples s(j, b, X)=b+R(j)δ(X, b)+P(j) are generated, where R(j) is a random scalar in some range (e.g., [0.5, 2.0]) and P(j) is a zero mean random vector. The random sample depends on b, X, and the random numbers that depend on j. For each sample s(j, b, X), the correct category, Y, is also known. In some aspects, additional noisy or distorted data can be generated, at step 707, by adding noise or distortion directly to example b, with no term dependent on X. These data can be treated as a special case, extra value of X.

The set S of all noisy samples generated by the above example procedure may be partitioned based on the value of Y, the correct answer. It may also be partitioned based on the value of Z, the output value computed by a particular classifier, to be explained below.

An illustrative aspect of robust training is shown in FIG. 8. FIG. 8 illustrates a system 831, wherein an autoencoder 821 is trained with two objectives and a classifier 810 (e.g., a deep neural network) is also trained. The autoencoder 821 includes an encoder 804 (e.g., a deep neural network) and a decoder 805 (e.g., a deep neural network) that receives a feature vector 805 from the encoder 804. This autoencoder 821 is trained with a combination of clean data from T and the noisy data that was generated from B (e.g., via the process illustrated in FIG. 7), with the proportion controlled by learning coach 101 based on the a priori estimate of the frequency of occurrence of noisy data of this type and prior experience of learning coach 101 on similar problems. It should be noted that in FIG. 8, activation proceeds in the direction of the arrows and backpropagation of partial derivatives proceeds in the opposite direction.

FIG. 8 also shows a recognizer 802 that has previously been trained on clean data. In this diagram, let X be the incorrect category towards which the adversarial noise is trying to push the classification. X is known at the time of creation of the noise and of the training, but not in operation. Further, let Y be the correct category. Y is known for training data, but not for operation. Further, let Z be the classification made by the non-robust classifier 802 when recognizing noisy data. Z can be determined for either training data or operation data simply by running classifier 802 on the data. Further, the training of the classifier 802 may be specific to Z.

Because Y, the correct category, is what the system wants to learn, it is useful to group training data based on Y, even though Y is not known for operation data. This means that, to be sure that the correct value of Y is included in operation, either all the values of Y can be included in an ensemble or all the data for different values of Y can be grouped together.

Because Z is known both for training data and for operation data, it is also useful to group training data by the value of Z. Because Z is known for both training and operation, it can be used for multi-stage systems as well as for ensembles.

Grouping by Z can be used as an approximate substitute for grouping by X. That is, because adversarial noise based on X tries to get the non-robust classifier 802 to misrecognize the pattern as an instance of X. Therefore, on noisy adversarial data generated by X, the classifier 802 will often recognize the noisy data as X, so that Z will often be equal to X.

Each noisy data example has been designed to cause the classifier 802 to misclassify the data. Z will be equal to X if the noisy data example fools classifier 802 as intended. Z may be equal to Y if the noisy data example fails to fool classifier 802, or it may be equal to some other category. In any case, Z is known and is computed the same way in operation as in training, so it can be used to partition the training data T, either to create an ensemble of classifiers or to create a multi-stage classifier. In this illustrative aspect, a multi-stage classifier will reduce the computation both during training and during operation. In this illustrative aspect, the training data T is not partitioned based on the value of X.

In this illustrative aspect, the data T may also be partitioned based on the value of Y, the correct category, either independent of the partition on Z, or as a joint, finer partition. Because Y is not known in operation, the partition on Y can only be used to create an ensemble of classifiers, not a multi-stage classifier. Because the direction of the adversarial noise is expected to be quite different when conditioned on different values of either Y or Z, it is reasonable to expect the members of an ensemble partitioned on either of them to be complementary.

In the illustrated exemplary aspect, the autoencoder 821 is trained to produce the clean input data 808, as close as it can, given the noisy data 801. The autoencoder 821 is also trained with the objective of helping classifier 810 have a low cost of classification errors. It is trained to this objective by continuing the backpropagation done in training classifier 810 back through the nodes representing the estimated clean input data 807 and from there back through the autoencoder 821 network. The backpropagation from the clean input data 808 as a target output and the classifier 810 simultaneously trains the autoencoder 821 according to the two objectives.

Switch 809 selects whether classifier 810 is to receive a copy of the actual clean input data 808 or the estimated clean input data 807 produced by the autoencoder 821. This selection can be made to match the a priori ratio of clean to noisy data in operation, possibly with some amount of additional noisy data specified by learning coach 101 to make the machine learning system 100 more robust. Note that learning coach 101 can make this judgement in part by measuring performance on held out development data. When classifier 810 receives its data from the clean input 808, it does not propagate partial derivatives back to the autoencoder 821.

In various aspects, the clean input data 808 may not be known in operation. Therefore, as the autoencoder 821 becomes well trained and relatively stable in its ability to estimate the clean input data, the learning coach 101 can increase the dropout of backpropagation from the clean data objective 808 to the autoencoder 821 network. In cases in which this dropout occurs and switch 809 selects clean data 808, classifier 810 is trained on the clean data example, but the autoencoder network does not receive backpropagation from either the clean data copy 808 or from classifier 810. Conversely, the classifier 810 continues to receive both clean input data 808 and cleaned up noisy data (i.e., estimated clean input data 807) in the proportion controlled by learning coach 101.

Once the training illustrated in FIG. 8 is complete, the network shown in FIG. 8, with the clean input 808 switched off, can be used as a classifier in operation. In one aspect, the switch 809 can in operation always select the estimated clean input data 807 once training is completed.

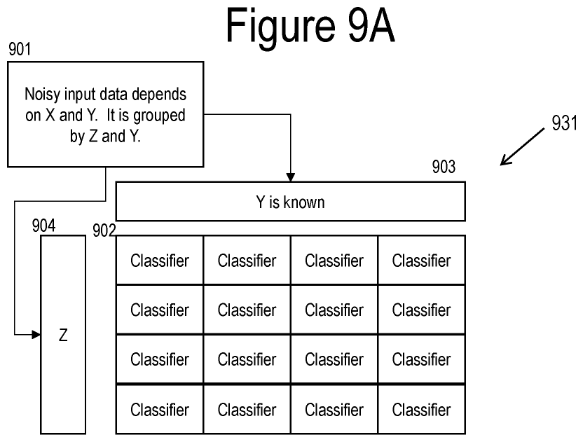

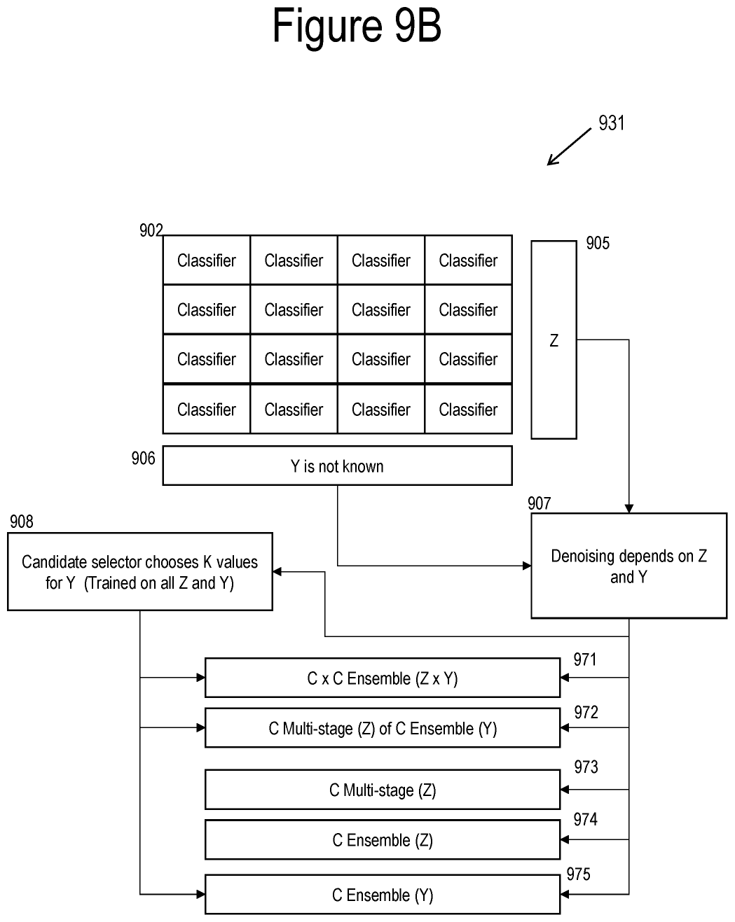

The training process in this aspect produces many different classifiers based on the values of Y and Z, as shown in the example of FIG. 9A. Each classifier depicted in FIG. 9A includes a classifier 810 paired with an autoencoder 821 that have been trained together on a set of noisy data that is specific to the pair <Y, Z>, as described in FIG. 8, for example. At step 901, the classifiers are grouped according to the values of Y and Z on which each classifier has been trained. As indicated in step 901, there is training data for each category Y and, for each value of Y, there is noisy adversarial data attempting to cause non-robust classifier 802 to recognize an instance of Y as an instance of X instead. However, because X is not known in operation, the data is grouped by Y, the correct category, and Z, the category as recognized by classifier 802. Because both Y and Z are known for training data, the trained classifiers can be arranged in a matrix 902, in which, for example, the value of Y determines the column 903 and the value of Z determines the row 904.

At operation time, depicted in FIG. 9B, Y is not known, so in the groupings described below, either the training must group together the training for the Y values, or each value of Y must be represented in an ensemble, as represented by the column 906 of the matrix 902. Since the value of Z is known, or can be determined, in operation, the value of Z can be used either to separate data in a multi-stage system or to create an ensemble, as represented by the row 905 of the matrix 902.

In the illustrative aspect, the autoencoder training data is grouped into sets that depend on Y and Z. The data for each pair <Y, Z> can be used as a separate training set. Keeping the sets separate creates C×C different classifiers, where C is the number of categories (i.e., the number of values for Y and Z). This grouping is referred to as “G1” below. Alternately, all the values of Z are kept separate while all the Y values are grouped together, creating C classifiers, one for each value of Z. This grouping is called “G2.” In another aspect, all values of Y are kept separate while the values of Z are grouped together, creating C, one for each value of Y. This grouping is called “G3.” Finally, all the training data can be grouped together, creating one classifier. This grouping is called “G4.”

In operation, this illustrative aspect of a system 931 receives noisy data at step 901. At step 907, the system attempts to do the corresponding denoising. In one aspect, there is a denoising autoencoder for each of the classifiers in the matrix 902. However, the value of Y is not known in operation, so at step 907 the system 931 groups the denoising operation and classification into at least one of the groupings 971, 972, 973, 974, or 975 (or G4).

The value of Z, the category recognized by classifying the noisy input, is known both during training and during operation. Thus, either grouping G1 or grouping G2 can be implemented as a multi-stage machine learning system with the classification of Z on the noisy input data as the first stage. These groupings can also be implemented as ensembles. The grouping G3 must be implemented as an ensemble and grouping G1 must be implemented as an ensemble with respect to Y, because Y is only known during training, not during operation. Except for grouping G4, these alternative aspects of the groupings 971, 972, 973, 974, and 975 are illustrated in FIG. 9.

Some aspects can choose the type of grouping in the aspect shown in FIG. 9 based on the number of categories. For example, with a small number of categories, the joint partition of aspects of grouping G1 971, 972 is used and the number of samples J generated is large enough so that there is sufficient data for each element of the partition member. With a large number of categories, either aspects of grouping G2 973, 974 or aspects of grouping G3 975 may be used. A single classifier C-All is used in some aspects. In addition, classifier C-All and/or the classifier trained on clean data 802 can be added to any ensemble in some aspects.

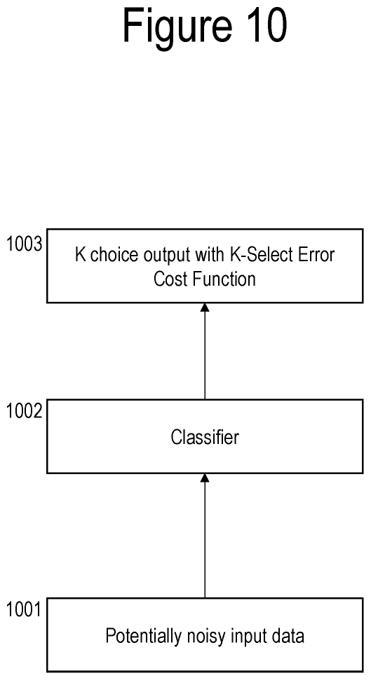

At step 908, an aspect of the system 931 groups all the training data, like grouping G4. According to various aspects, the process illustrated by FIG. 10 can be used for this purpose. The purpose of the classifier shown in FIG. 10 is to select a smaller number of categories so that, among the ensemble members that are based on different values of Y, classification is done only for the selected values of Y, saving a substantial amount of computation. The illustrative aspect is designed to optimize the likelihood that the correct category is in a list of K selected categories.

In applications such as image recognition, speech recognition, and natural language processing, the number of categories may be in the tens or hundreds of thousands. This illustrative aspect uses a specially designed classifier K-Select that produces an output with K of the categories activated, with K being a number controlled by learning coach 101, according to various aspects. The input data 1001 to the classifier K-Select 1002 shown in FIG. 10 is the estimated clean input data generated by the G4 denoising autocorrelator that has grouped together the data for all values of Y and all values of Z. The output layer of classifier K-Select has C nodes, one for each category. In FIG. 10, activation proceeds in the direction of the arrows and backpropagation of partial derivatives proceeds in the opposite direction.

The classifier K-Select 1002 can be trained, for example, using stochastic gradient descent with backpropagation, but it can use a different error cost function 1003 than a normal classifier. Back propagation or another error cost function 1003 optimizes performance of correct answer being among K choices. Since the classifier K-Select 1002 is only used to select the K candidate categories, but not to choose among them, it does not matter how the correct answer is ranked among these top K categories, but only whether the correct answer is included. Therefore, various aspects can utilize an error cost function that reflects this objective.

For each training example, one illustrative aspect first computes the activations and finds the K top scoring categories of the inputs values to the output nodes (the input value to each output node is also called its “raw score” herein). If the correct answer is included in the top K raw scores, then the K-choice output 1003 normalizes these K raw scores to give activations that sum to 1. In this case, the other activations are set to 0. If the correct answer is not included in the top K scores, then the K-choice output 1003 normalizes the raw scores for all C categories to give activations that sum to 1. Thus, in this aspect a different cost function is used depending on whether the correct answer is among the K best raw scores. This cost function is just one illustrative example of a cost function that seeks to optimize the selection performance of classifier K-Select 1002. Other aspects may use different cost functions that aim at this objective. For example, in one aspect, backpropagation is only done when the correct answer in not in the top K best raw scores. Another aspect sets the output of each of the best raw scores to the maximum of the raw scores. In each of these aspects, normal backpropagation, with no score changes, can be done when the correct answer is not among the K-best raw scores.

In operation, classifier K-Select 1002 selects the K best raw scores and it does not need to perform the normalization. Referring again to FIG. 9, if one of groupings 971, 972, or 975 is to be used, then step 908 performs classification with a classifier, such as the one illustrated FIG. 10, to select only K candidate categories. Then in the groupings 971, 972, or 975, only ensemble members with Y values in the set of K candidates are used.

In some aspects of step 908, the clean data classifier is always added to the set of ensemble members selected by K-Select.

FIG. 11 illustrates three example aspects of step 104 of FIG. 1A. The three examples aspects may be roughly characterized as follows: (1) minibatch size, the number of data examples accumulated in estimating the gradient for each parameter update; (2) the temperature of a node with a parametric sigmoid( ) tanh( ), or softmax activation function or a hyperparameter with a similar property for some other activation function; or (3) the asymptotic slope for extreme positive or negative input values of the activation function of a node.

The temperature and asymptotic slope hyperparameters were introduced as examples in association with the discussion of step 104 of FIG. 1A. As was noted, as the temperature of a parametric sigmoid activation function is decreased to zero, the function converges toward a step function. For some activation functions with a non-zero asymptotic slope, letting both the temperature and the asymptotic slope converge to zero causes the activation function to converge to a step function or to some other piecewise constant function. That is, in these cases, the derivative of the activation function is zero almost everywhere. Such activation functions can make a neural network robust against small incremental changes in the input.

However, if a set of nodes forming a cutting set of the network all have activation functions with zero derivatives almost everywhere, then the partial derivatives of the error cost function will also be zero for all those nodes and for all the nodes and connection weights in lower layers of the network. Therefore, with the exception of certain designated nodes, the process of having the temperature and asymptotic slope hyperparameters converge to zero should be postponed until the final phase of the learning process.

To achieve the purpose of delaying the lowering of the temperature or asymptotic slope hyperparameters, it is necessary to at least tentatively determine when the learning process is in the final stage and to be able to reset the learning to an earlier phase if it turns out that the learning process in not yet in the final stage. FIG. 11 illustrates an example embodiment of a process for determining and controlling various phases of the learning process. Although not directly affecting the robustness of the final network, controlling the minibatch size helps to diagnose and control the phases of the learning process, so it will be discussed first, before the other hyperparameters.

In each of these example aspects, step 1101 determines the initial value for one or more hyperparameters associated with the example. Then, over an interval of one or more minibatches, step 1102 then collects statistics by which step 1103 estimates the current phase of the learning process. For example, step 1103 may estimate that the learning process is currently in an initial phase, in the main phase of learning, in a special phase called the monotonic improvement phase, or is the final phase of learning. In some embodiments, step 1103 may estimate whether the learning process is in a phase of steady progress, or if it in a phase or slower progress, perhaps caused by being close to a saddle point or when converging to a local or global minimum. The criteria for estimating the phase of the learning process are different for the three example aspects.

In an aspect where the minibatch size is changed, there is a relationship between the size of the minibatch and the accuracy of the estimate of the gradient from statistics based on a single minibatch. If the data items for each minibatch are random samples independently selected from the same distribution of training data examples, the standard deviation of the estimate of each component of the gradient will vary in inverse proportion to the size of the minibatch. Thus, a larger minibatch will tend to be more accurate in the sense that the estimate will have a lower standard deviation. On the other hand, a smaller minibatch requires less computation per update and allows more updates per epoch. However, if the minibatch-based gradient estimate is computed by parallel computation, for example on a general purpose graphic processing unit, then there is little advantage in decreasing the size of the minibatch to be less than the number of data items that can be computed in parallel. In such a parallel implementation, the number of examples that can be computed in parallel effectively sets a lower bound on the minibatch size. More generally, even when the computation is implemented as a sequential computation, prior experience and/or hyperparameter tuning can be used to determine a minimum minibatch size below which the larger standard deviation in the estimate of the gradient is unacceptable. Either of these determinations of a minimum effective minibatch size is set as the initial minibatch size in step 1101 and is also enforced as a minimum value for the minibatch size in later processing.

However, later in the training, the variability of the minibatch-based estimates may begin to dominate the measure of performance as measured on a single minibatch as well as affecting the estimates of the gradient. A performance statistic that is computed for each training data example, and that can be accumulated over each minibatch, is the error cost function. If the exact gradient is known and the learning step size is small enough, then there should be a monotonic improvement in the error cost function for every update. Step 1102 estimates the standard deviation of the minibatch-based estimate of the error cost function and a trend line for the error cost function, for example by fitting a linear regression model to the trend over multiple minibatches. The slope of the trend line is the estimate of the amount of improvement in the error cost function per minibatch update. In some tasks, initial learning progress will be relatively slow and the slope of the trend line for the error cost function may be close to zero. In such a task, step 1104 designates this phase as the initial learning phase until step 1105 detects an improvement in the error cost function trend line. In this initial phase, step 1106 leaves the minibatch size at its initial, minimum value.

In most cases, step 1105 eventually detects a more productive learning phase, in which the improvement in the error cost function per update is greater than the estimated standard deviation of the error cost function. When this condition is detected, step 1105 designates this phase as the main learning phase. If this condition is never detected, then the minibatch size stays at its initial value unless either the system designer or the learning coach 101 of FIG. 1B specifies an alternate criterion for determining the change to the main learning phase. Some examples of such intervention are discussed in association with FIG. 12.

In the main learning phase, the minibatch size may be increased or it may be decreased if it is not at its minimum value. If the improvement in the error cost function per minibatch update is less that a specified multiple of the standard deviation, then the value of having two updates per two minibatches is less than the value of one more reliable updates. In this case, step 1105 doubles the minibatch size or increases its size by some other multiple specified by a hyperparameter under control of learning coach 101 of FIG. 1B. If the improvement in the error cost function per minibatch is greater than a specified multiple of standard deviation of the estimate of the error cost function, then the minibatch size is decreased by step 1105 if it is not already at its minimum value set by step 1101. To prevent step 1105 from flipping frequently back and forth between increasing and decreasing the minibatch size, step 1104 preferably imposes an additional criterion, such as by having a separation between the threshold that causes a change in one direction from the threshold that causes a change in the other direction. Alternately, step 1104 may simply impose a holding period preventing any change from being made too soon after a change in the opposite direction.

Eventually, the learning process will approach a stationary point and the magnitude of the gradient will approach zero. As the magnitude of the true gradient approaches zero, the slope of the trend line of the error cost function will also approach zero. Under the rules described above, the minibatch size will be increased as long as the specified multiple of the standard deviation of the error cost function is larger than the slope of the trend line. However, the limiting case is for the minibatch to be the full training set in which case the computed gradient for the minibatch is the actual gradient for the error cost function, evaluated on the full training set. In this limiting case, if the learning step size is small enough, a condition enforced by steps 1108-1110, then the error cost function will be monotonically decreasing for each minibatch update. Step 1107 causes steps 1108-1111 to be applied in the monotonic improvement learning phase.

Among other things, step 1106, which is an illustrative embodiment of step 105 in FIG. 1A, can occur in any phase of the learning process. However, it is applied only occasionally, if at all, and it causes the learning phase to be reset when it is applied. Its discussion is postponed so as to not disrupt the continuity of the discussion.

After a specified number of updates resulting in successive monotone improvements in the error cost function, step 1105 signals detection of a monotone improvement phase, which may either be temporary, such as when approaching a saddle point, or permanent, such convergence toward a local or global minimum. In this monotone improvement phase, unlike the main learning phase, a change in the minibatch size is not triggered by the relative size of the standard deviation of the estimated gradient, as long as the improvement remains monotonic. An increase in the minibatch size can be caused by the failure of the mechanism of step 1108-1110 to find a step size small enough to achieve a monotonic improvement, which should never happen for a continuously differentiable error cost function if the minibatch is the full training set. In the absence of any other mechanism to change the minibatch size, the minibatch size can increase but never decrease during the monotonic improvement phase. Eventually, the minibatch will grow to be the full batch and the iterative stochastic gradient descent will be become exact gradient descent and steps 1108-1110 should always be able to find a monotonic improvement.

In the case of convergence to a minimum, the full batch gradient descent iterative training converges to the exact minimum rather than to a random walk in the vicinity of the minimum, as does stochastic gradient descent based on smaller minibatches. This exact convergence is helpful in the hyperparameter-controlled convergence to more robust node activation functions used in other aspects of FIG. 11 and step 104 of FIG. 1A. Thus, when a training process is in a monotone improvement phase converging to a minimum and the minibatch size has been increased to the full batch, it is undesirable to return to the main learning phase and decrease the minibatch size. The slope of the trend line and the magnitude of the gradient will be close to zero in the vicinity of the minimum, so the direction of the gradient can be greatly misestimated with only a small deviation in the gradient estimate.

On the other hand, the condition of monotonic improvement in the error cost function as well as a slow learning rate due to a gradient with a small magnitude can also occur when approaching a saddle point. Therefore, it is desirable to have an alternative criterion to allow step 1104 to detect the need for a change in the learning phase in this situation. In one aspect, this criterion comes from measurements taken in step 1111, as explained in more detail in association with FIG. 12.

When the learning process is in a monotonic improvement phase, step 1107 sends control to step 1108, otherwise step 1107 returns control to step 1102.

Step 1108 evaluates the performance change, that is, the change in the error cost function due to the most recent iterative update. If there has been an improvement in performance, control is sent to step 1110. If there is a degradation in performance, control is sent to step 1109. In iterative training based on gradient descent or minibatch-based stochastic gradient descent, each update in the parameters is made by a change in the learned parameters in the direction of the negative of the estimated gradient. This change in the learned parameters is called a “step.” The size of the step is controlled by a hyperparameter called the learning rate. In each update, the negative gradient is multiplied by the learning rate to determine the step size. Block 1109 decreases the size of the step in the negative gradient direction by decreasing the value of the learning rate hyperparameter. Similarly, block 1110 increases the size of the step in the negative gradient direction by increasing the value of the learning rate hyperparameter.

In prior art systems, the learning rate hyperparameter can be set to a fixed value, which may be optimized by hyperparameter tuning. However, recommended best practice in the prior art is to use a learning rate schedule that gradually decreases the learning rate. The reason for decreasing the learning rate is to decrease the step size so that, at convergence, the random walk in the vicinity of the minimum tends to be confined to a smaller volume of parameter space. However, in one aspect of the invention described herein, the method is different from this prior art recommended best practice. If the minibatch size has been increased such that each learned parameter update is based on the full batch training set, the iterative update is in the direction of the true gradient of the error cost function as evaluated on the training data so the iterative update is in the exact direction of the negative gradient rather than in the direction of a stochastic estimate of the negative gradient. Therefore, there is deterministic convergence to a minimum rather than pseudo-convergence to a random walk in the vicinity of the minimum. Thus, there is no need to decrease the learning rate, except as done in step 1109. To the contrary, in this situation, decreasing the learning rate only slows down the learning.

The task of the steps 1108, 1109, and 1110 is to adjust the learning rate to be as large as possible while avoiding destroying the property of monotonic performance improvement caused by taking an update step that is too large. When the size of the minibatch is less than the full size of the training set, an update step may result in degraded performance due to either of two causes: (1) the step size may be too large, or (2) the direction of the stochastic estimate of the gradient is not sufficiently accurate. In a preferred embodiment, step 1109 both decreases the learning rate and increases the minibatch size unless the minibatch is already the full training set.

On the other hand, when the minibatch is already the full batch, the degradation can only be due to the step size of the iterative update being too large, so in this circumstance, in this aspect, the learning rate parameter is decreased, but the size of the minibatch is unchanged. That is, the minibatch is left to be the full training set.

As stated before, the collective task of steps 1108, 1109, and 1110 is to adjust the learning rate to be as large as safely possible. Viewed geometrically, an update step can be too large and cause a degradation in performance either because a large step jumps past the stationary point that the process is performing or because a large step causes the update to fail to follow the contour of a narrow, curving valley in the error cost function. When the training process is approaching a stationary point, the magnitudes of the gradient approaches zero. It is possible to experimentally estimate the safe learning rate. In one preferred embodiment, for example, the learning rate is increased by step 1110 during successive passes through the loop from step 1107 through step 1108 and 1110 back to 1102. This increase in the learning rate continues until a degradation in performance causes control to pass to step 1109.

If the minibatch size is already the full batch, or if learning coach 101 in FIG. 1B otherwise decides that the degradation in performance is due to the step size being too large rather than due to an error in the stochastic estimate of the gradient, then step 1109 attempts to estimate the largest safe learning rate. Note that this estimated safe learning rate depends on the geometry and shape of the contours of the error cost function near the stationary point being approached, not on a global property of the error cost function. Therefore, in one aspect step 1109 makes a separate estimate of the maximum safe learning rate for each stationary point that the learning process approaches. In one example aspect, step 1109 estimates the maximum safe learning rate as a fractional multiple of the learning rate at the last update step that resulted in an improvement in performance. The fractional multiplier is controlled by a hyperparameter. For example, in some embodiments, the fraction is set to 0.5. In such embodiments, the learning rate is kept to no worse than 0.5 times the maximum safe learning rate. Step 1110 has different behavior depending on whether or not step 1109 has estimated a maximum safe learning rate for the stationary point that is currently being approached. Once step 1109 has made an estimate of the maximum safe learning rate, step 1110 is changed so that it leaves the learning rate unchanged, rather than increasing it. The behavior of step 1110 remains in this state of not increasing the learning rate until there is a change in the learning phase or until it is detected that the iterative learning process has begun to move away from a stationary point that has turned out to be a saddle point rather than a minimum.

An aspect of the invention described herein is the difference in the learning procedure followed during the monotonic improvement learning phase from standard stochastic gradient descent learning procedures and from the procedure during the main learning phase of the process illustrated in FIG. 6. There are two main differences: (1) when the standard deviation of the error cost function is comparable to the estimated improvement per minibatch update, the size of the minibatch is increased; (2) when the standard deviation of the error cost function is small, in particular when it is zero because the minibatch is the full set of training data, the learning rate is increased to close to maximum safe value. Procedure (1) is an appropriate action whenever the magnitude of the gradient remains small for a number of minibatch updates sufficient for an estimated trend line with a slope near zero. In particular, it is preferable when learning process is approaching a stationary point in the error cost function, as well as in other situations with a trend of slow learning.

When the learning process is converging to the global minimum of the error cost function, it is preferable for the procedures of the incremental improvement learning phase to be maintained until final convergence. However, when approaching a saddle point or local minimum, eventually it becomes desirable to make a change. Step 1111 collects statistics that help make the decision of when to make such a change and what kind of change to make, as explained in more detail in association with FIG. 12.

Step 1111 measures the change in the gradient across an interval of one or more updates. From that information, step 1111 estimates the derivative of the gradient as a function of the number of updates and also measures the rate of change of the direction of the gradient. It records a history of these values. This information is included in the data gathered by step 1102 and is used in the decisions made by steps 1103 and 1104. In a preferred embodiment, these decisions are based in part on patterns in the history gathered by step 1111, with the patterns being recognized by learning coach 101 in FIG. 1B. This decision process based on recognition of patterns in the progress of the learning procedure is described in more detail in association with FIG. 12.

Returning now to the postponed discussion of step 1106, one of the actions that can be taken based on the gradient change statistics gathered by step 1111 and on other statistics, is to make a change in the network, for example by adding a node to the network in step 1106. The decision to change the network can be made at any time, for any of several reasons. For example, step 1202 of FIG. 12 may detect a pattern that indicates an opportunity to accelerate learning or to improve performance by adding a special node. For example, step 1202 may detect an opportunity to improve the performance on a particular data item or an opportunity to improve the discrimination between a particular pair data items. Preferably, step 1202 looks for such opportunities when it detects a pattern of slow learning progress or when learning coach 101 of FIG. 1B detects a problem. In a preferred embodiment, the special node to be added may be either a template node, initialized by one-shot learning from a single data item, or a discrimination node, initialized by one-shot learning from a pair of data items. Adding a node may be done to accelerate the learning because step 1202 detects an opportunity to accelerate learning by immediately learning something that cannot be learned immediately by gradient descent. Adding a node may also be done because step 1202 detects an opportunity to improve performance by escaping from a local minimum. Adding a node may even escape from the global minimum of the current network configuration because the global minimum of the current network might only be a saddle point for the expanded network. Step 1106 may also change the network by dropping a node, for example, as indicated by a performance test in step 1205 of FIG. 12. Preferably the learning phase is reset to the main learning phase following a change in the network. This network change decision and the other statistics involved are discussed in more detail in association with FIG. 12.

FIG. 11 also estimates the learning phase for hyperparameters other than the minibatch size and adjusts their schedule of value changes based on the learning phase. For example, FIG. 11 estimates the learning phase and the schedule of value changes for the temperature hyperparameter for the sigmoid and sigmoid-like activation functions and also for hyperparameters that have an effect like temperature for other activation functions. In a preferred embodiment, both the temperature-like hyperparameters and the asymptotic slope hyperparameters are adjusted on a schedule aimed at increasing the robustness of the final network by adjusting the activation function of one or more nodes so as to create one or more intervals of the range of input values of a node over which the output value is constant or has a derivative that approaches zero as the training process converges. In the extreme, the activation functions of one or more nodes approach piecewise constant functions. In one aspect, the set of nodes converging to piecewise constant functions is a cutting set for the network. That is, for every path from the input to the network to the output of the network, there is at least one node on that path whose activation function is converging towards a piecewise constant function.

However, since the derivative of a piecewise constant function is zero except at the points of discontinuity, iterative training based on gradient descent is not possible. Furthermore, although gradient descent iterative learning is still possible for activation functions that have non-zero derivatives while they approximate a piecewise constant function, the progress of the learning process slows down as the derivatives of the activation function approach zero. Therefore, the schedule of adjustments to the temperature-like and asymptotic slope hyperparameters is preferably postponed until the last stage of convergence to the final network, with certain exceptions to be discussed below. That is, the adjustment of these hyperparameters is postponed until it has at least tentatively been decided that there will be no further changes in the network in step 105 or step 106 of FIG. 1A and until the process of FIG. 11 is in the monotonic improvement for a stationary point that is tentatively identified as the target for final convergence. In some aspects, this final convergence phase may begin any time during a monotonic improvement phase. In other embodiments, it is further delayed until the minibatch size is the full training batch.

If there is a change in the network or a change in the learning phase of the process in FIG. 11, then in one aspect the temperature and asymptotic slope hyperparameters revert to their default values for all nodes, except for nodes that are specifically exempted. There are several reasons that such an exempted node might be allowed to train to have one or more constant value regions in its activation function. In fact, one of the most popular activation functions, a rectified linear unit (ReLU), initially and permanently has a constant value of zero for all input values less than zero. That is, ReLU(x)=0 for all x<0. Therefore, it is also preferable in some embodiments to allow the parameter or hyperparameter p to converge to zero in a parametric ReLU defined by pReLU(x)=px for x<0, pReLU(x)=x for x≥0.

Another reason to allow the activation function of one or more nodes to converge to have one or more constant value intervals or even to be a piecewise-constant function is to reduce the number of degrees of freedom of the parameters in order to reduce over-fitting. Yet another reason to allow the activation functions of a set of nodes to converge to piecewise constant functions is to create definitive features in a set of feature nodes, especially if the target features are predetermined or potentially identifiable. The connection weights for the arcs coming into a node with a piecewise-constant activation function will not be changed by subsequent iterative gradient descent or stochastic gradient descent training.

In some embodiments, this lack of change during further training is another advantage in addition to those already mentioned. During subsequent training, other parts of the network can rely on the stability of such a node or a set of such nodes. In some embodiments, it is clearly an advantage to have a set of stable feature nodes on which other parts of the network can build and train more complex features. Another advantage is that in some embodiments, a subnetwork culminating in a set of stable feature nodes can be copied from one network to another with its meaning and interpretation preserved. Yet another advantage of a piecewise constant activation function is that it requires fewer bits to encode the activation value than for a general activation function. For example, it only requires one bit to encode the activation level of a step function.

In an aspect as a distributed system with limited data bandwidth among remote components, an advantage of a piecewise-constant activation function is that it requires fewer bits to represent the degree of activation and thus that information for a larger number of nodes can be transmitted through a data channel of fixed bandwidth. For these and other reasons, in some embodiments, one or more nodes are allowed to converge to have one or more constant intervals in their activation functions before other nodes have converged and to not have their activation functions changed even when the architecture of the network is changed.

Steps 1103, 1104, 1106, and 1110 make decisions that affect the learning process and steps 1103 and 1111 collect data to be used in making those decisions. FIG. 12 illustrates an aspect of the invention in which these decisions are formulated as pattern recognition problems handled by a separate machine learning system, such as learning coach 101 of FIG. 1B.

Step 1201 collects the data to be used for controlling the learning process and for setting the hyperparameters. That is, step 1201 gathers the data collected in steps 1102 and 1111 of FIG. 11. Step 1201 gathers data not just for a single minibatch, but rather keeps a historical record of the useful measurements and statistics for each minibatch and for each epoch. If the magnitude of the gradient is close to zero for the current minibatch, it is immediately apparent that the amount of improvement from the current update will probably be small. However, to properly analyze the current status of progress in the learning process and to make decision about the learning strategy and the learning phase, more information is needed, such as changes in the magnitude and direction of the gradient from one update to the next or an even longer record of the history of these and other measurements of the progress of the learning process.

In FIG. 12, step 1201 gives two examples of data to be collected. These are only illustrative examples. Many other examples may be used in various embodiments of the invention described herein. For example, any of the following may be used:
1) The history of changes in the direction of the gradient of the error cost function with respect to the learned parameters, recorded for each update in the sequence of updates;
2) The history of first differences of the gradients of the error cost function, that is the difference between the gradient at one update and the gradient at the previous update, recorded for each update in the sequence of updates;
3) The sequence of magnitudes of the gradients;
4) The sequence of error cost function values evaluated averaged across each minibatch and, in some embodiments, evaluated for each data item;
5) The sequence of activation values of the target output node for one or more selected data items recorded for the instance of each selected data item, once per epoch; and
6) The correlation of the activation values of the target output nodes for a pair of data items with different target nodes, with the correlation accumulated over multiple epochs.
   Additional examples may be used in various embodiments.

Step 1202 performs a pattern recognition process to detect patterns that help estimate the learning phase or other characteristics of the current status of the learning process. Step 1202 also performs pattern recognition to detect potential problems in the learning process and to diagnose those problems.

In FIG. 12, step 1202 gives several examples of patterns to be detected. These are only illustrative examples. Many other examples may be used in various embodiments of the invention described herein. For example, any of the following may be used:
1) Detection of a subsequence of the sequence of gradient magnitude that is predominately monotonic;
2) Detection of a subsequence of the sequence of differences in successive gradient magnitudes that is predominately monotonic;
3) Detection of a change in the rate of change in the direction of the gradient, especially when it is not associated with a change in a hyperparameter;
4) Regression of a trend line of the sequence of error cost function values, evaluated for each minibatch update, and
   a. Detection of the condition that the residual of the regression is larger than a specified multiple of the slope of the trend line, or
   b. Detection of the condition that the residual of the regression is smaller than a specified multiple of the slope of the trend line;
5) Detection that the error cost function has increased during the monotonic improvement learning phase;
6) Detection of a lack of improvement in the activation of a target output node for a data item over an interval of epochs relative to the amount of improvement in the activation of other the target nodes for other data items, especially when the data item is being misclassified or its activation score is within a specified threshold of being misclassified; and
7) Detection of a pair of data items, with different target classifications, for which the correlation of the activations of the respective target output nodes for the pair of data items is larger than a specified value.

The decisions to be made in steps 1103, 1104, 1106, and 1110 comprise deciding when to change the learning phase, when to change the minibatch size, when to change the learning rate, and when to make a change in the network architecture, such as adding or deleting a node. In various aspects, many of these decisions are made during intervals of slow learning, that is, intervals during which the slope of the trend line of the error cost function is close to zero. Among the situations in which this condition may be true are the following: (a) when the system is in a broad flat region of parameter space, possibly with isolated maxima, but with no minima or saddle points, (b) when approaching a minimum, (c) when randomly walking in the vicinity of a minimum, (d) when approaching a saddle-point, and (e) when receding from, but still in the vicinity of, a saddle point. Different learning strategies and different decisions are desired, depending on which of these situations is true. It may also be important, to the extent possible, to distinguish the approach to a local minimum from the approach to the global minimum.

Some illustrative examples of patterns that may distinguish one of these situations from another are as follows:
1) When approaching a stationary point during the monotonic improvement phase, the magnitude of the gradient tends to decrease monotonically with occasional exceptions. The corresponding condition is harder to detect if the residual of the regression of the error cost function is relatively large compared to the slope of the trend line.
2) In the final approach to a minimum with full batch gradient updates, the rate of change of the direction of the gradient is relatively small compared to the approach to within a comparable vicinity of a saddle-point.
3) When receding from a saddle-point, the magnitude of the gradient tends to increase, albeit slowly.
4) When a gradient descent update steps past a minimum, the direction of the gradient will tend to reverse suddenly. That is, a sequence of updates with small changes in the direction of the gradient between each successive pair of updates will be followed by a pair of gradient directions with an angle θ between their directions that is close to π, say θ>3π/4. This phenomenon will also be true when the approach to the minimum is repeated with a smaller learning rate that approaches closer to the minimum, helping to distinguish this situation from one in which the learning rate is merely too large.
5) When a sequence of gradient descent updates progresses past a saddle point, the amount of change in the direction of gradient will tend to increase gradually and then begin to decrease gradually.
6) In the vicinity of a local minimum or saddle-point there will often be one or more data items for which the activation of the target output node does not improve significantly even though that activation is less than or not much greater than the activation of the best scoring wrong answer.
7) In the vicinity of a saddle-point there may be a pair of data items that are not being distinguished even though they have different classification categories. In some cases, the result is that activations of their respective target output nodes are highly correlated over an interval of multiple epochs. In fact, the activation values for the pair of data items may be highly correlated for all points in the vicinity of the saddle point.

Learning coach 101 of FIG. 1B is trained by prior experience on other problems to detect these and other patterns. Learning coach 101 may also be trained to discover new useful patterns based on unsupervised or self-supervised learning. In this self-supervised learning, learning coach 101 verifies the performance enhancing value of a putative pattern and an associated decision by measuring the effect of the decision for instances of detection of the putative pattern on multiple example machine learning problems.

Step 1203 takes actions based on the patterns detected in step 1202 and other measurements. In an example aspect, whenever the residual of a regression on the error cost function is larger than a specified multiple of the slope of the trend line, the size of the minibatch will be increased. If a pattern is detected indicating an approach to a stationary point, then the learning phase is changed to the monotonic improvement phase, if it is not already.

In some embodiments, learning coach 101 may have knowledge of the performance that it expects or hopes to achieve, based on prior experience or based on previously achieved performance on a benchmark. If the current performance is significantly worse than the desired performance, then any approach to a stationary point is assumed to be an approach to a local minimum or saddle point. When such a situation is detected, in some embodiments learning coach 101 may add one or more nodes to the network, such as a one-shot template node if example pattern (6) above is detected and/or a one-shot discrimination node if example pattern (7) above is detected. In some embodiments, this action to add one or more nodes may be taken without iterating the training to within the vicinity of the stationary point. Such early action may accelerate the learning process by putting the model on a trajectory with better performance than the stationary point being approached.

On the other hand, in some embodiments, learning coach may avoid adding a node to the network if a stopping criterion has been reached, for example if previous testing of added nodes in steps 1204 and 1205 has resulted in a number of rejections that has reached some limit. In other cases, the decision to add a node may be postponed until the training process has approached close enough to the stationary point to decide whether the stationary point is a minimum or a saddle-point.

If a pattern is detected that the learning has passed the vicinity of a saddle-point and is now receding from that saddle-point, in some embodiments, the training phase is reset to the main learning phase. In some embodiments, this reset is delayed until the learning process has more fully receded from the saddle point.

In some embodiments, the learning phase is reset to the main learning phase as soon as a node is added to the network. In other embodiments, this reset is delayed until evidence is gathered to determine if an existing pattern is still detected.

In a preferred embodiment, when a one-shot learning node is added to a network, the new node receives connections directly from the input nodes of the network and has outgoing connections directly to the output nodes of the network. The new node may be placed in any layer of the network, or even between two layers, creating a new layer of its own. In some embodiments, the new node may also have connections from lower hidden layers and connections to higher hidden layers. In such embodiments, the connections to other nodes in hidden layers may either be created at the time the node is created or at a later time. The weights of such additional connections are initialized to zero.

When a node is added to a network, step 1204 marks that node for delayed decision performance testing. In addition, step 1204 keeps track of the data item or pair of data items that are associated with the node if the node is initialized by one-shot learning. In some embodiments, other nodes are also selected for delayed decision performance testing. These nodes may be selected at random, by a selection criterion specified by the system developer, or by a selection criterion learned by learning coach 101 from prior experience.

The delayed decision performance testing is done by step 1205. In one aspect, the performance testing is delayed so that step 1205 can test multiple nodes at the same time. In some aspects a single node may be tested in some circumstances. The performance test compares the performance of multiple networks. In each network, a subset of the nodes being tested are randomly selected to be dropped from the network, with an independent random selection for each of the networks.

The performance of each network is measured on validation data, and a regression function is computed with a set of Boolean-valued independent variables representing for each node whether the node is present in the network. For each node, the node's contribution to the performance is measured by its coefficient in the regression of the performance.

In a case of overfitting, the coefficient for a node may be negative. In some embodiments, all nodes with negative coefficients are dropped. In other embodiments a node is dropped only if a null hypothesis can be rejected at some level of statistical significance. In some embodiments, a node is dropped unless a null hypothesis can be rejected in favor of the node. Since the process of finding new node candidates can continue, any rejected node may eventually be replaced. Similarly, any accepted node can be retested and can later be rejected if sufficient evidence is accumulated.

When node is rejected by a performance test as described above, it is an indication of overfitting the training data. In some embodiments, a different remedy to this overfitting is applied. Rather than a node being dropped, the corresponding data item used to initialize the node in one-shot learning is dropped from the training set. For a discrimination node initialized by one-shot learning, the data item to be dropped is the member of the pair of discriminated data items that was mislabeled.

Learning coach 101 preferably imposes a stopping criterion on the introduction of new nodes. When that stopping criterion is met, learning continues past any saddle points until a pattern is detected that the learning is approaching the vicinity of a minimum. Preferably, the learning phase is changed to final stage learning and the temperature and asymptotic slope hyperparameters for designated nodes are set on a schedule to converge to zero.

In some embodiments, one or more copies of the network and its learned parameters are made earlier in the training process before the final convergence to the minimum. In some embodiments, once convergence to the minimum is confirmed, the state of the network one of these prior copies and the final stage learning phase is started from that point. In some embodiments, this decision to restart at an earlier state of the learning process is based on the performance of the final network.

Various aspects of the subject matter described herein are set out in the following aspects, implementations, and/or examples:

A method for increasing a robustness of a neural network comprising an input layer, a hidden layer, and an output layer includes adding a trained bias to a node of the input layer.

In one implementation, the bias comprises a summand to an activation function of the node.

In one aspect, a method for increasing a robustness of a neural network comprising an input layer, a hidden layer, and an output layer includes increasing a minibatch size of a training data set for training the neural network.

In one implementation, the minibatch size is increased until the minibatch size is equal to a size of the training data set.

In one implementation, the minibatch size is increased to the size of the training data set over a plurality of iterations. In another implementation, the minibatch size is increased to the size of the training data set over a single iteration.

In one implementation, the method includes utilizing a fixed minibatch size during a normal learning period during training of the neural network, determining whether the training of the neural network is approaching a stationary point, and then increasing the minibatch size as the training of the neural network approaches a stationary point.

In one implementation, the method includes determining whether training of the neural network is in a monotonic learning phase and then increasing the minibatch size according to whether the training is in the monotonic learning phase. Further, the minibatch size can be increased to a size of the training data set.

In one aspect, a method for increasing a robustness of a neural network comprising an input layer, a hidden layer, and an output layer includes changing a hyperparameter controlling an activation function of a node to cause the activation function to tend to converge such that the activation function that is more robust against incremental changes in an input to the node.

In one implementation, the hyperparameter controlling the activation function of the node controls a value of a derivative of the activation function at a local maximum in the value of the derivative of the activation function. Accordingly, changing the hyperparameter in the method includes changing the value of the derivative of the activation function in a way to cause the value of the derivative to diverge towards infinity.

In one implementation, the hyperparameter controlling the activation function of the node controls a slope of an asymptote to the activation function. Accordingly, changing the hyperparameter in the method includes changing the slope of the asymptote in a way to cause the slope of the asymptote to converge towards zero.

In one implementation, the method further includes determining whether training of the neural network is converging and changing the hyperparameter controlling the activation function of the node according to whether the training of the neural network is converging. In one further implementation, changing the hyperparameter in the method includes causing the activation function of the node to approach a constant value on an interval of input values to the function.

In one implementation, the hyperparameter comprises a learning rate parameter controlling a step size of the update. This implementation of the method further includes determining whether an update in training of the neural network improves a performance of the neural network according to an objective function and changing the hyperparameter controlling the activation function of the node according to whether the update improved the performance of the neural network according to the objective function. The objective function can include, for example, an error cost function.

In one implementation, the hyperparameter controlling the activation function of the node causes the activation function to converge towards a piecewise constant function. In one further implementation, a set of nodes having activation functions each converging towards a piecewise constant function can form or define a cut set of the neural network.

In one aspect, a method for increasing a robustness of a neural network comprising an input layer, a hidden layer, and an output layer includes adding a special node to the neural network, the special node comprising a non-monotonic activation function.

In one implementation, the special node is programmed to compute a second order polynomial for a set of nodes of the neural network.

In one implementation, the special node is a member of a set of nodes programmed to function as a softmax gate for a set of nodes of the neural network.

In one implementation, the special node includes a template node programmed such that a derivative of its activation is close to zero relative to changes in data that are far from a template value of the template node.

In one implementation, the special node is programmed to function as a Gaussian mixture distribution model.

In various implementations, the special node can be added prior to training the neural network, during training of the neural network, and/or after training the neural network.

In one aspect, a method for increasing a robustness of a neural network comprising an input layer, a hidden layer, and an output layer includes implementing a softmax gate to select which of a plurality of values should be passed through to a higher level node.

In one implementation, the softmax gate comprises a first set of nodes of the neural network whose joint set of activations represent a set of softmax values and wherein the set of softmax values are utilized to gate output values of a second set of nodes of the neural network to the higher level node of the neural network. In one further implementation, the activations of the softmax gate are defined for node k of the first set of nodes as Zₖ=exp(zₖ)/Σⱼexp(zⱼ), where zⱼ is the input to node j.

In one aspect, a method for increasing a robustness of a neural network comprising an input layer, a hidden layer, and an output layer includes adding a special node trained by one-shot learning.

In one implementation, the special node trained by one-shot learning comprises a template node initialized from a data example. In one further implementation, the template node utilizes a non-monotonic activation function. In various still further implementations, a maximum value of the template node is achieved for an input matching the data example or a minimum value of the template node is achieved for an input matching the data example.

In one implementation, the special node trained by one-shot learning comprises a discrimination node initialized to distinguish a pair of data examples.

In one aspect, a method for increasing a robustness of a neural network comprising an input layer, a hidden layer, and an output layer includes applying a transformation to the input to make the neural network more robust against adversarial changes.

In one implementation, applying the transformation to the input includes a quantization step.

In one aspect, the method includes causing the activation function for a node is to converge to an activation function that is more robust against incremental changes to the input to the node. In one implementation, such changes to a set of nodes cause the set of nodes to together form a cut set of the neural network.

In one aspect, the method includes creating a node that is a template for a data item. The template node can, for example, use a non-monotonic activation function. In a further aspect, the non-monotonic activation function may have its maximum value or its minimum value be achieved for an input that matches the data item.

In one aspect, the method includes detecting two data items that have two different output category targets where the activations of the output nodes corresponding to the two different output category targets are correlated across all training data items, with a correlation value above some specified threshold value.

In one aspect, the method includes computing a regression function estimating the error cost function or some other measure of the error as a function of the number of iterative training updates. In one implementation, the method includes estimating this regression function for a sliding window of iterative updates. In one implementation, the method includes estimating statistical measures based on the regression computation, with the statistical measures comprising the slope of a trend line and a measure of the statistical spread of the residual from the trend line.

In one aspect, the method includes utilizing different learning strategies for different phases of the learning process. In one implementation, the method can utilize a fixed minibatch size during normal learning and increase the minibatch size during approach to a stationary point. In one implementation, the method can perform certain steps only during the final stage of convergence. For example, during this final stage and only during this final stage, this aspect of the invention may adjust hyperparameters causing the activation function of a node to approach an activation function with an interval for which the value of the activation function is constant.

In one aspect, the method includes utilizing a monotonic improvement learning phase. In one implementation, the method attempts to make each iterative update during the monotonic learning phase improve the error cost function or other objective function. For example, during the monotonic learning phase this implementation of the method can cause the minibatch size to be equal to the full batch of training data. As another example, this implementation of the method can decrease the step size of an attempted iterative update and then re-try the update if the attempted iterative update did not result in an improvement in the error cost function or other objective function. This aspect of the invention may dynamically change a learning rate parameter based on it needs to make such changes in the step size of an update.

In one aspect, the method includes collecting statistics of the change in the error cost function and accordingly performing a pattern recognition process on the collected statistic to estimate whether the learning process is in the vicinity of a stationary point. A further aspect of the invention includes collecting additional statistics, such as the rate of change of the direction of the gradient of the error cost function or the angle between the gradient directions for two successive updates. This aspect further includes utilizing these additional statistics to perform a pattern recognition process to estimate whether the learning process is in the vicinity of a saddle point, rather than in the vicinity of a minimum. A further aspect of the invention includes utilizing these statistics to perform a pattern recognition process to determine whether the learning process is approaching or receding from a saddle point. A further aspect of the invention includes utilizing the estimates of these pattern recognition processes to make decisions about potential changes in the learning strategy.

In one aspect, the method includes testing the performance of a set of variant networks of the network being trained in which different subsets of the nodes in the network being trained are present in various members of the set of variant networks. A further aspect of the invention includes computing a regression function estimating the error cost function of each variant network as a function of a vector of Boolean variables representing which nodes are present in each variant network. Further aspect of the invention includes utilizing the coefficients of the regression function as part of a decision of whether to delete a node from the network being trained. A further aspect of the invention includes utilizing the coefficients of the regression function as part of a decision of whether to delete or give less weight to a data item that is associated with a node that has been initialized by one-shot training.

In one aspect, a method for increasing a robustness of a neural network comprising an input layer, a hidden layer, and an output layer includes determining a gradient direction of data examples of the training data with respect to a set of input nodes of the input layer, splitting the data examples according to the gradient direction, and retraining the neural network on the split data examples.

In one implementation, the gradient direction is determined via a clustering algorithm.

In one implementation, the clustering algorithm includes a first encoder and a second encoder. The first encoder is programmed to output a sparse representation of a set of direction vectors for the gradient of an error cost function for the neural network with respect to a selected set of nodes of the neural network. The second encoder is programmed to receive the sparse representation from the first encoder and map the sparse representation to a set of clusters. Accordingly, the set of clusters are utilized to split the data examples according to the gradient direction.

In various further implementations, the sparse representation can include an n-tuple where n is less than a dimensionality of the input, an n-tuple where k elements of the n-tuple are non-zero and k is less than n, and/or a parametric representation where a number of parameters of the parametric representation is less than a dimensionality of the input.

In various further implementations, the selected set of nodes of the neural network can include the set of input nodes of the input layer and/or the special node(s).

In one implementation, the selected set of nodes are selected by a learning coach controlling the neural network.

In one implementation, the clustering algorithm comprises a multi-stage classifier.

In one implementation, retraining the neural network on the split data examples includes generating a set of copies of the neural network, where a number of the set of copies is equal to a number of clusters of the split data examples, and accordingly training each of the set of copies of the neural network on one of the clusters of the split data examples.

In one implementation, the method includes combining the set of copies of the neural network trained on one of the clusters of the split data examples as an ensemble. In various implementations, results from the ensemble can be combined by at least one of a maximum score, an arithmetic average, or a geometric average.

In one aspect, a method for increasing a robustness of a neural network comprising an input layer, a hidden layer, and an output layer includes generating data for causing errors in the neural network.

In one implementation, generating data for causing errors in the neural network includes splitting the training data into a first training data subset and a second training data subset, training the neural network on the first training data subset, selecting a data element from the second training data subset, computing an activation gradient of an output node of the output layer corresponding to an incorrect category, and accordingly generating random data samples from the activation gradient of the output node corresponding to the incorrect category.

In one implementation, generating data for causing errors in the neural network further includes adding distortion to the data element selected from the second training data subset.

In one implementation, generating data for causing errors in the neural network further includes providing the random data samples generated from the activation gradient of the output node corresponding to the incorrect category to an autoencoder, selectively providing an output of the autoencoder and the training data to a classifier (where the output of the autoencoder represents an estimate of the training data), and training the autoencoder to reproduce the training data from the random data samples according to an output of the classifier.

In one implementation, the output of the autoencoder and the training data are selectively provided to the classifier according to an expected data noisiness frequency. In one implementation, a proportion of the output of the autoencoder selectively provided to the classifier is greater than the expected data noisiness frequency. In one implementation, a ratio between the output of the autoencoder and the training data provided to the classifier selectively provided to the classifier is controlled by a learning coach.

In one implementation, the method further includes providing the random data samples generated from the activation gradient of the output node corresponding to the incorrect category to a second classifier.

In one implementation, the autoencoder and the classifier, when trained, define an operational classifier. Thus, a plurality of operational classifiers are generated according to a plurality of subsets of the random data samples.

In one implementation, the method further includes grouping the plurality of operational classifiers according to a classification of the second classifier as an ensemble. In another implementation, the method further includes grouping the plurality of operational classifiers according to a correct classification as an ensemble. In another implementation, the method further includes grouping the plurality of operational classifiers according to both an output of the second classifier and a correct classification as an ensemble. In yet another implementation, the method includes grouping all of the operational classifiers together as an ensemble.

In one implementation, the method further includes denoising data from the plurality of operational classifiers and training a K-select classifier to select K candidate categories from C categories of an output of the second classifier and a correct classification.

In one implementation, a value of K is controlled by a learning coach.

In one implementation, training the K-select classifier includes normalizing input values of the selected K candidate categories according to whether a correct classification is within the selected K candidate categories and normalizing input values of all C categories according to whether a correct classification is not within the selected K candidate categories.

In one aspect, the method for increasing a robustness of a neural network further comprises training the neural network to a desired performance criterion.

In various implementations, one or more of the aforementioned aspects, implementations, methods, and/or steps described thereof can be arranged together in any combination or order, unless they are specifically described as mutually exclusive from each other.

In various implementations, one or more of the aforementioned methods and steps thereof can be embodied as instructions stored on a memory of a computer system that is coupled to one or more processor cores such that, when executed by the processor cores, the instructions cause the computer system to perform the described steps. In various aspects, the one or more processor cores can include, for example, one or more GPUs and/or one or more AI accelerators.

In various implementations, one or more of the aforementioned methods and steps thereof can be executed by a learning coach controlling the neural network. Alternatively, in various implementations the aforementioned computer system can comprise the learning coach controlling the neural network.

Thus, based on the above description, it is clear that aspects of the present invention can be used to improve many different types of machine learning systems, including deep neural networks, in a variety of applications. For example, aspects of the present invention can improve recommender systems, speech recognition systems, and classification systems, including image and diagnostic classification systems, to name but a few examples, principally by making them more robust to small or imperceptible changes to the input data.

Referring back to FIG. 1B, the machine learning system 100 and the learning coach 101 can be implemented with computer hardware and software. For example, they could be part of an integrated computer system (e.g., a server or network of servers) that has multiple processing CPU cores. One set of cores could execute the program instructions for the machine learning system 100, another set for the learning coach 101, and so on. The program instructions could be stored in computer memory that is accessible by the processing cores, such as RAM, ROM, processor registers or processor cache, for example. In other aspects, some or all of the machine learning system 100 and learning coach 101 could execute on graphical processing unit (GPU) cores, e.g. a general-purpose GPU (GPGPU) pipeline, or processing cores of an AI accelerator chip(s) (ASICs). GPU cores operate in parallel and, hence, can typically process data more efficiently that a collection of CPU cores, but all the cores execute the same code at one time. AI accelerators are a class of microprocessor designed to accelerate artificial neural networks. They typically are employed as a co-processor in a device with a host CPU as well. An AI accelerator typically has tens of thousands of matrix multiplier units that operate at lower precision than a CPU core, such as 8-bit precision in an AI accelerator versus 64-bit precision in a CPU core. Also, machine learning system 100 and the learning coach 101 could be part of a distributed computer system. For example, the computer devices (e.g., servers) that implement the machine learning system 1100 and the learning coach 101 may be remote from each other and interconnected by data networks, such as a LAN, WAN, the Internet, etc., using suitable wired and/or wireless data communication links. Data may be shared between the various systems using suitable data links, such as data buses (preferably high-speed data buses) or network links (e.g., Ethernet).

The software for the various machine learning systems described herein (e.g., the machine learning system 100 and the coach learning system 101) and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1-9. (canceled)

10. A method for increasing a robustness of a neural network comprising an input layer, a hidden layer, and an output layer, the method comprising:
increasing a minibatch size of a training data set for training the neural network.

11. The method claim 10, further comprising:
changing a hyperparameter controlling an activation function of a node to cause the activation function to tend to converge such that the activation function that is more robust against incremental changes in an input to the node.

12. The method of claim 11, further comprising:
adding a special node to the neural network, the special node comprising a non-monotonic activation function.

13. The method of claim 12, further comprising:
implementing a softmax gate to select which of a plurality of values should be passed through to a higher level node.

14. The method of claim 13, further comprising:
adding a special node trained by one-shot learning.

15. The method of claim 14, further comprising:
applying a transformation to the input to make the neural network more robust against adversarial changes.

16. The method of claim 10, wherein the minibatch size is increased until the minibatch size is equal to a size of the training data set.

17. The method of claim 16, wherein the minibatch size is increased to the size of the training data set over a plurality of iterations.

18. The method of claim 16, wherein the minibatch size is increased to the size of the training data set over a single iteration.

19. The method of claim 10, further comprising:
utilizing a fixed minibatch size during a normal learning period during training of the neural network;
determining whether the training of the neural network is approaching a stationary point; and
increasing the minibatch size as the training of the neural network approaches a stationary point.

20. The method of claim 10, further comprising:
determining whether training of the neural network is in a monotonic learning phase; and
increasing the minibatch size according to whether the training is in the monotonic learning phase.

21. The method of claim 20, wherein the minibatch size is increased to a size of the training data set.

22. The method of claim 10, wherein the method is executed by a learning coach controlling the neural network.

23. A method for increasing a robustness of a neural network comprising an input layer, a hidden layer, and an output layer, the method comprising:
changing a hyperparameter controlling an activation function of a node to cause the activation function to tend to converge such that the activation function is more robust against incremental changes in an input to the node.

24-29. (canceled)

30. The method of claim 23, wherein the hyperparameter controlling the activation function of the node controls a slope of an asymptote to the activation function.

31-38. (canceled)

39. A method for increasing a robustness of a neural network comprising an input layer, a hidden layer, and an output layer, the method comprising:
adding a special node to the neural network, the special node comprising a non-monotonic activation function.

40-43. (canceled)

44. The method of claim 39, wherein the special node is a member of a set of nodes programmed to function as a softmax gate for a set of nodes of the neural network.

45. The method of claim 39, wherein the special node comprises a template node programmed such that a derivative of its activation is close to zero relative to changes in data that are far from a template value of the template node.

46. The method of claim 39, wherein the special node is programmed to function as a Gaussian mixture distribution model.

47-50. (canceled)

51. A method for increasing a robustness of a neural network comprising an input layer, a hidden layer, and an output layer, the method comprising:
implementing a softmax gate to select which of a plurality of input values should be passed through to a higher level node of the neural network.

52-53. (canceled)

54. The method of claim 51, wherein the softmax gate comprises a first set of nodes of the neural network whose joint set of activations represent a set of softmax values and wherein the set of softmax values are utilized to gate output values of a second set of nodes of the neural network to the higher level node of the neural network.

55-56. (canceled)

57. A method for increasing a robustness of a neural network comprising an input layer, a hidden layer, and an output layer, the method comprising:
adding a special node trained by one-shot learning.

58-78. (canceled)

79. A computer system for increasing a robustness of a neural network comprising an input layer, a hidden layer, and an output layer, the computer system comprising:
one or more processor cores; and
a memory coupled to the one or more processor cores, the memory storing instructions that, when executed by the one or more processor cores, cause the computer system to:
increase a minibatch size of a training data set for training the neural network.

80-148. (canceled)
